(19) United States
(12) Patent Application Publication
(10) Pub. No.: US 2025/0307036 A1
(43) Pub. Date: Oct. 2, 2025

(54) Managing Object Lock Settings During Cross-Grid Replication Within A Distributed Storage System

(71) Applicant: NetApp, Inc., San Jose, CA (US)

(72) Inventors: Andrea Suet Yee Chan, Vancouver (CA); Lawrence Yu, New Westminster (CA); Gregory Kent, Vancouver (CA)

(73) Assignee: NetApp, Inc., San Jose, CA (US)

(21) Appl. No.: 19/089,893

(22) Filed: Mar. 25, 2025

Related U.S. Application Data
(63) Continuation-in-part of application No. 18/616,662, filed on Mar. 26, 2024.

(51) Int. Cl. G06F 9/52; G06F 21/62

(52) U.S. Cl. CPC G06F 9/526; G06F 21/6209

(57) ABSTRACT

Various embodiments of the present technology generally relate to systems and methods for providing managing object lock settings during cross-grid replication within distributed storage systems. In an example, ingestion of an object into a first grid of a distributed storage system may be detected. Responsive to detecting ingestion of the object, object lock settings for the object may be determined. Once the object lock settings are determined, the object lock settings may be validated against destination object lock settings. If the destination object lock settings are validated, cross-grid replication of the object may be initiated. During cross-grid replication, the object lock header may be provided in a replication payload transmitted from the first grid to a second grid. When the object is replicated, the destination object lock settings may be determined for the object, which may include the object lock settings as identified in the object lock header.

### TECHNICAL FIELD

Various embodiments of the present technology generally relate to distributed storage systems. More specifically, embodiments of the present technology relate to systems and methods for managing object lock settings during cross-grid replication within distributed storage systems.

### BACKGROUND

In the digital era, the exponential growth of data generation and consumption has necessitated advanced storage systems capable of efficiently managing and accommodating large volumes of information. A distributed storage system addresses this need by storing and managing data across multiple interconnected nodes or servers rather than relying on a centralized location. This decentralized approach enhances scalability, fault tolerance, and performance, allowing organizations to expand storage capacity seamlessly by adding more nodes to the network. Additionally, distributed storage systems employ redundancy mechanisms and data replication strategies to improve data durability and availability, mitigating the risk of data loss due to hardware failures or unforeseen events. As such, distributed storage systems are increasingly relied upon in modern computing environments, supporting applications and services that require high availability, reliability, and efficient data access.

One advantage of distributed storage systems is the redundancy provided through data replication. When an object, such as a file or dataset, is introduced into a node within a grid, the distributed storage system initiates a dynamic replication process, distributing copies across multiple nodes. This mechanism enhances data reliability, fault tolerance, and accessibility while also optimizing data retrieval and load balancing. However, single-storage grid replication has vulnerabilities, including the risk of unauthorized access, which could compromise the integrity of replicated data. A reliance on a single storage grid introduces a significant risk, as any failure or outage of the grid renders all stored data inaccessible, disrupting applications and operations. This centralized dependency limits fault tolerance and increases the potential impact of system-wide failures, whether due to hardware malfunctions, network disruptions, or cyberattacks. Additionally, ransomware threats exploit the interconnected nature of replicated data within a single grid, enabling malicious actors to simultaneously encrypt all copies stored within the system.

Accordingly, there exists a need for improved technologies that provide cross-grid replication processes while maintaining object lock settings, such as those provided herein.

The information provided in this section is presented as background information and serves only to assist in any understanding of the present disclosure. No determination has been made and no assertion is made as to whether any of the above might be applicable as prior art with regard to the present disclosure.

### OVERVIEW

Technology is disclosed herein for systems and techniques for providing cross-grid replication between two or more storage grids within a distributed storage system. In an aspect, technology for managing object lock settings for objects during cross-grid replication is described herein. For example, an object lock engine may be leveraged for managing the object lock settings. When an object is ingested into a first grid within a distributed storage system, the object lock engine may detect the ingestion. In some embodiments, the object is ingested into a source bucket on the first grid. The source bucket may be within a tenant defined on the first grid. Responsive to detecting ingestion of the object, the object lock engine may determine object lock settings for the object. The object lock settings may include one or more policies or rules governing the retention of the object within the distributed storage system. For example, the object lock settings may define a retention mode and a retention period for the object.

To determine the object lock settings, the object lock engine may parse an ingestion request associated with the ingestion of the object into the first grid. The ingestion request may include object-level lock settings for the object. If the ingestion request contains the object-level lock settings, then the object lock engine may apply the object-level lock settings to the object as source object lock settings. However, if the object is ingested without object-level lock settings defined, the object lock engine may determine the source object lock settings based on any governing bucket-level lock settings.

Responsive to determining the object lock settings for the object, the object lock engine may generate an object lock header for the object. The object lock header may include the object lock settings for the object, and in some cases, may be part of a replication payload. The replication payload may include the object data, the object metadata, and the object lock header. Once generated, the object may be cross-grid replicated to a second grid within the distributed storage system. In particular, the object may be cross-grid replicated to a destination bucket on the second grid.

In some embodiments, prior to cross-grid replicating the object, the object lock engine may validate destination object lock settings. That is, the object lock engine may validate that object lock is enabled on the second grid, in particular, on the destination bucket. In some cases, the object lock engine may also validate that any tenant-level or bucket-level object lock settings defined on the second grid for a designated bucket and/or tenant matches the source object lock settings of the object. The object lock settings identified for the object as ingested on the first grid may be defined as source object lock settings. As such, during the validation process, the object lock engine may validate that the source object lock settings match the destination object lock settings. If the object lock engine determines a conflict or mismatch between the source object lock settings and the destination object lock settings, then the object lock engine may pause or otherwise prevent cross-grid replication of the object.

When a conflict is detected between source object lock settings and destination object lock settings, the object lock engine may generate a validation error. The validation error may be provided to a client device that is associated with the ingestion of the object into the first grid. Responsive to receiving the validation error, the client device may be prompted to modify one or both of the source object lock settings or the destination object lock settings. When the modification is made, the object lock engine may reinitiate cross-grid replication of the object.

Once the object is cross-grid replicated to a destination bucket on the second grid, the object lock engine may determine which object lock settings to apply to the object. For example, if the object is replicated with the object lock header, the object lock engine may extract the source object lock settings from the object lock header and apply the source object lock settings as the destination object lock settings to the object. However, if the object is replicated without an object lock header, the object lock engine may determine the governing destination object lock settings of the destination bucket (or tenant) and apply the destination object lock settings to the object.

This Overview is provided to introduce a selection of concepts in a simplified form that are further described below in the Detailed Description. It may be understood that this Overview is not intended to identify key features or essential features of the claimed subject matter, nor is it intended to be used to limit the scope of the claimed subject matter.

### BRIEF DESCRIPTION OF THE DRAWINGS

The accompanying drawings, which are incorporated into and constitute a part of this specification, illustrate one or more certain aspects and, together with the description of the example, serve to explain the principles and implementations of the certain examples.

FIG. 1 illustrates an example operational environment for a system for providing cross-grid replication to a client device, according to an embodiment herein.

FIG. 2 illustrates an example distributed storage system for providing cross-grid replication, according to an embodiment herein.

FIG. 3 illustrates an example process for performing cross-grid replication, according to an embodiment herein.

FIG. 4 illustrates an example flow for performing a cross-grid replication process, according to an embodiment herein.

FIG. 5 illustrates an example operational system for performing cross-grid replication, according to an embodiment herein.

FIG. 6 illustrates an example cross-grid replication process, according to an embodiment herein.

FIG. 7 illustrates an example flow of a cross-grid replication process, according to an embodiment herein.

FIG. 8 illustrates an example distributed storage system having multiple dispersed storage grids, according to an embodiment herein.

FIG. 9 illustrates an example logical architecture 900 of a distributed storage system, according to an embodiment herein.

FIG. 10 illustrates an example operational environment leveraging an object lock engine, according to an embodiment herein.

FIG. 11 illustrates a process for providing an object lock engine on a source side during cross-grid replication, according to an embodiment herein.

FIG. 12 illustrates a process for providing an object lock engine on a destination side during cross-grid replication, according to an embodiment herein.

FIG. 13 shows an example computing device suitable for providing one or more steps of a cross-grid replication process and/or an object lock engine process, according to an embodiment herein.

Some components or operations may be separated into different blocks or combined into a single block for the purposes of discussion of some of the embodiments of the present technology. Moreover, while the technology is amenable to various modifications and alternative forms, specific embodiments have been shown by way of example in the drawings and are described in detail below. The intention, however, is not to limit the technology to the particular embodiments described. On the contrary, the technology is intended to cover all modifications, equivalents, and alternatives falling within the scope of the technology as defined by the appended claims.

### DETAILED DESCRIPTION

In the modern era, the escalating generation and consumption of data have necessitated the adoption of advanced storage solutions, leading to an increased reliance on distributed storage systems. Distributed storage systems offer a scalable and efficient means of managing vast amounts of information by distributing data across interconnected nodes or servers. As organizations strive to cope with the exponential growth of digital data, distributed storage systems have become indispensable for their ability to provide high availability, reliability, and seamless scalability.

Traditional distributed storage systems often confine data replication to a single storage grid (hereinafter referred to as “intra-grid replication”) which can leave the distributed storage system vulnerable to a variety of challenges and disadvantages. As used herein, a storage grid (also referred to herein as “a grid”) is a distributed storage architecture comprising a cluster of interconnected storage nodes that function and are managed as a unified system. A grid may span a single site or multiple sites and can be deployed on-premises, in a private cloud, a public cloud, or in a hybrid cloud configuration. Data (e.g., objects) ingested at any location within the grid can be accessed or retrieved from any other location within the same grid. Traditional distributed storage systems often confine data replication to a single grid (i.e., intra-grid replication), which can limit fault tolerance, geographic redundancy, and resilience across multiple grids within the same distributed storage system.

One significant concern with single grid storage is the heightened vulnerability to localized failures or storage grid outages. That is, in traditional distributed storage systems, if a storage grid experiences a hardware failure or becomes inaccessible, the replicated data within that storage grid becomes at risk, potentially leading to data loss and operational disruptions. Moreover, the limited scope of redundancy within a single storage grid leaves the entire distributed storage system susceptible to a single point of failure, compromising data integrity and availability. Additionally, conventional distributed storage systems face difficulties in providing effective disaster recovery solutions, as the localized replication limits the geographical dispersal of redundant data. This constraint hinders the system's ability to withstand broader disasters or catastrophic events, impacting data resilience. Furthermore, scalability can be constrained, as expanding storage capacity within a single storage grid may lead to performance bottlenecks and increased management complexity.

To address the shortcomings of traditional distributed storage systems, systems and processes for cross-grid replication are provided herein. As will be expanded on below, cross-grid replication addresses the evolving demands of data management while fortifying distributed storage systems against the limitations associated with traditional distributed storage architectures. Unlike the limitations associated with intra-grid replication, cross-grid replication offers a comprehensive solution to the vulnerabilities identified in conventional models. By extending the replication process beyond the confines of a single storage grid, cross-grid replication ensures increased data resilience and mitigates the risks associated with localized failures or outages. The intricate network of interconnected storage grids allows for the strategic dispersal of replicated data across diverse geographical or organizational locations, significantly reducing the susceptibility to single points of failure. This architectural advancement not only enhances data durability and availability but also establishes a robust foundation for disaster recovery by enabling broader geographical dispersal of redundant data. Furthermore, cross-grid replication promotes scalability, enabling seamless expansion of storage capacity across interconnected storage grids without compromising performance or management efficiency. In essence, cross-grid replication emerges as a pivotal solution to fortify the limitations of traditional distributed storage systems, providing a more resilient and responsive framework for modern data management needs.

For example, cross-grid replication serves as a formidable safeguard against the insidious threats posed by ransomware vulnerabilities and rogue administrators within distributed storage systems. In traditional, single-storage grid replication models, the interconnected nature of replicated data could amplify the impact of ransomware attacks, leading to widespread encryption and potential data loss. Cross-grid replication addresses this concern by strategically distributing replicated copies across multiple storage grids. This dispersal not only limits the impact of ransomware to a specific storage grid but also enables swift recovery from unaffected replicas in other interconnected storage grids. Additionally, the decentralized nature of cross-grid replication introduces a layer of security against rogue administrators. Unauthorized access to a single storage grid does not equate to unfettered control over all replicated data, as cross-grid replication ensures that administrative functions are distributed across interconnected nodes, mitigating the risk of malicious manipulation. In essence, cross-grid replication acts as a proactive defense mechanism, fortifying distributed storage systems against the evolving threats of ransomware and unauthorized access.

Implementation of cross-grid replication can introduce technical challenges in managing policies applied to replicated data. Maintaining policy consistency across multiple storage grids may be complex, as different grids often operate under distinct configurations, security protocols, and administrative controls. Achieving uniform enforcement of access controls, encryption standards, retention policies, and compliance mandates across separate grids may be required to minimize inconsistencies that could result in unauthorized access, data exposure, or regulatory concerns. For example, object lock settings, including retention mode and retention period, are policies that organizations commonly replicate to help preserve data immutability and maintain compliance with regulatory requirements. Any misalignment in object lock settings across grids has the potential to cause unintended consequences, such as premature data deletions, unauthorized modifications, or extended retention beyond intended timeframes, which may introduce legal and operational complexities. Additionally, differences in infrastructure and governance models between grids can add further challenges to policy propagation, potentially making centralized data management strategies more difficult to implement effectively.

Current data replication processes, including cross-grid replication, often prioritize the replication of object data itself, while the replication of policies governing that data may receive less attention. As a result, inconsistencies can arise when replicated objects are governed by different policies than the original data, leading to potential security, compliance, and operational challenges. Disparities in access controls may expose sensitive data to unauthorized users in one grid while restricting access in another, creating both security risks and usability concerns. Similarly, differences in object lock settings across grids could result in premature deletion of data in one location while retaining it longer than necessary in another, leading to compliance issues and unnecessary storage costs. Additionally, inconsistencies in regulatory compliance policies across grids can complicate audits and legal obligations, as data that is compliant in one environment may not meet the same standards elsewhere. This misalignment may expose the organization to legal and compliance risks, including regulatory penalties, contractual violations, and challenges in demonstrating adherence to industry standards, particularly in sectors with stringent data protection and retention requirements.

To address the shortcomings of managing policies during replication processes, in particular managing object lock settings during cross-grid replication, example technologies are provided herein. In particular, an example of an object lock engine is provided herein that manages policies applied to an object before and during cross-grid replication. As described in greater detail below, the object lock engine can determine the appropriate policies to apply to an object upon ingestion into a first grid. During the cross-grid replication process, the object lock engine coordinates these policies to ensure that the replicated object retains the appropriate policies at its destination on a second grid. It should be noted that while the following discussion focuses on object lock settings, other types of policies are also contemplated, including data retention policies, access control policies, encryption policies, and compliance policies.

The object lock engine provide herein offers significant security, compliance, operational, and technical benefits over conventional approaches. By automatically synchronizing access controls, encryption settings, object lock settings, and other governance policies across replicated data, the object lock engine aids in preventing inconsistencies that might otherwise lead to unauthorized access, data loss, or regulatory non-compliance. For example, by ensuring uniform policy enforcement across grids, the object lock engine reduces the risk of premature data deletion or prolonged retention, helping organizations align with legal and industry-specific data governance requirements. Additionally, maintaining policy consistency enhances auditability, streamlining compliance reporting and reducing the complexity of regulatory reviews.

From a technical perspective, the object lock engine integrates policy replication with data replication, thereby reducing the need for manual policy updates and minimizing latency in policy enforcement across distributed environments. The automated policy synchronization provided by the technology provided herein improves a distributed storage system's resilience by ensuring that security and compliance measures are consistently applied, even as data moves across different storage grids. Furthermore, the object lock engine enhances interoperability by standardizing policy enforcement across heterogeneous storage infrastructures, preventing misconfigurations that could arise from variations in grid architectures or administrative controls. By integrating policy replication within the cross-grid replication process, the object lock engine allows organizations to achieve greater efficiency, scalability, and reliability in managing distributed storage environments while mitigating risks associated with policy misalignment.

Various embodiments of the present technology provide for a wide range of technical effects, advantages, and/or improvements to computing systems and components. For example, various embodiments may include one or more of the following technical effects, advantages, and/or improvements: 1) non-routine and unconventional implementation of techniques for comprehensive object lock validation across multiple levels-tenant-level validation and bucket-level validation; 2) non-routine and unconventional implementation of techniques allowing for automatic and systematic object lock setting application and management across separate storage grids; 3) integration of non-routine and unconventional systems and algorithms designed to ensure localized validation and error handling to efficiently handle cross-grid object lock compliance; 4) integration of policy replication with data replication to reduce the need for manual policy updates and minimizing latency in policy enforcement across distributed environments; and/or 5) unique communication protocol to provide continuous monitoring and revalidation of object lock settings.

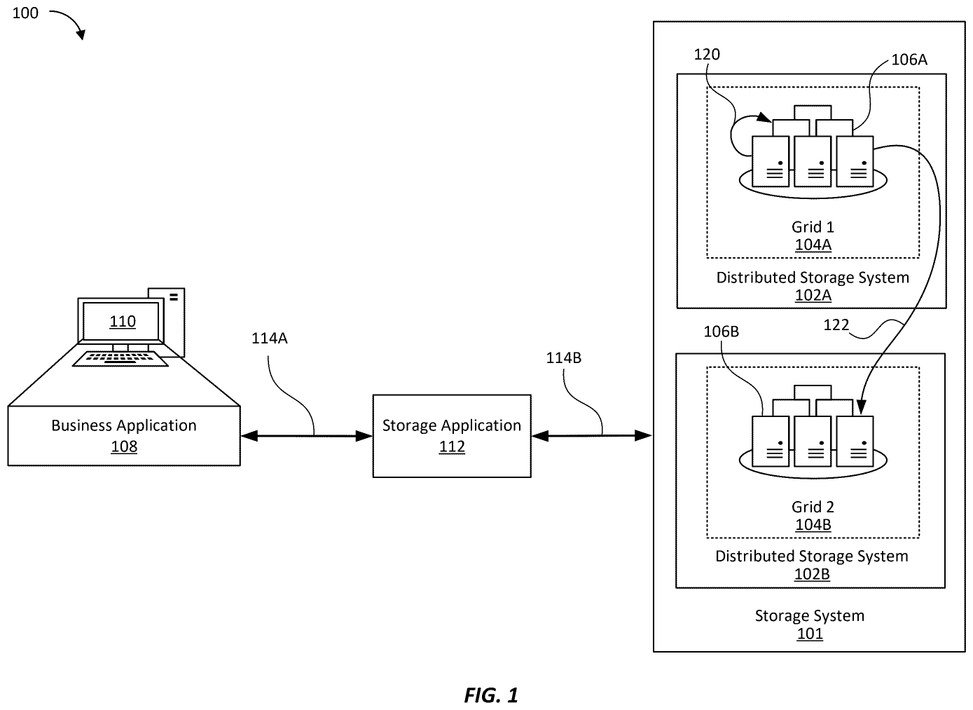

Turning now to the Figures, FIG. 1 illustrates an example operational environment for a system 100 for providing cross-grid replication to a client device 110, according to an embodiment herein. The storage grids may be implemented in a software defined architecture or as a more traditional hardware-centric storage solution. In some aspects, a storage grid may refer to a software-defined storage solution (e.g., object storage solution) designed to manage and store large amounts of data (e.g., unstructured data). A software defined storage architecture abstracts the management, control and provisioning of storage resources from the underlying hardware. This provides many benefits such as ease of management, scalability, flexibility, and resilience.

The multiple grids illustrated in FIG. 1 may be independently deployed and managed as interconnected systems of distributed storage architectures for many reasons. Some scenarios include, but are not limited to, disaster recovery and business continuity, data sovereignty and compliance, performance optimization, multi-tenancy and isolation, scalability and load balancing, and a variety of other special use cases. Each storage grid can offer policy-driven data management capabilities. These capabilities can allow administrators to define rules for data placement, retention, and lifecycle management. Moreover, these policies can help optimize storage usage, reduce costs, and ensure compliance with regulatory requirements. One example of these policies is object lock settings. Object lock settings allow users to set various modification policies.

As shown, the client device 110 may execute a business application 108 to manage associated data. Data associated with the business application 108 may be managed and stored on a storage system 101. That is, the storage system may serve as a backbone for storing, retrieving, and managing the data generated by the business application 108. It should be appreciated that while FIG. 1 illustrates a single client device 110 executing a single business application 108, in reality an organization or platform may include any number of client devices 110, each executing a separate instance of the business application 108. As such, it can be appreciated that the business application 108 may generate and require access to vast amounts of data stored on the storage system 101.

In the illustrated example, the storage system 101 includes two distributed storage systems 102A and 102B. At the core of each of the distributed storage systems 102A and 102B is a storage grid 104A and 104B, respectively. The storage grids 104A and 104B each include a logical framework that organizes and coordinates the storage and retrieval of data. The storage grids 104A and 104B may be software-defined, object-based storage solutions that support a single name space across multiple sites. That is, each of the storage grid 104A and 104B has its own namespace through which clients can access stored objects. As those skilled in the art readily appreciate, a namespace refers to a logical container or partition within a storage system where data is organized and managed based on predefined rules or criteria, enabling efficient data access, retrieval, and management. For example, the first storage grid 104A, as described herein, may be accessible via a first namespace while the second storage grid 104B is accessible via a second namespace.

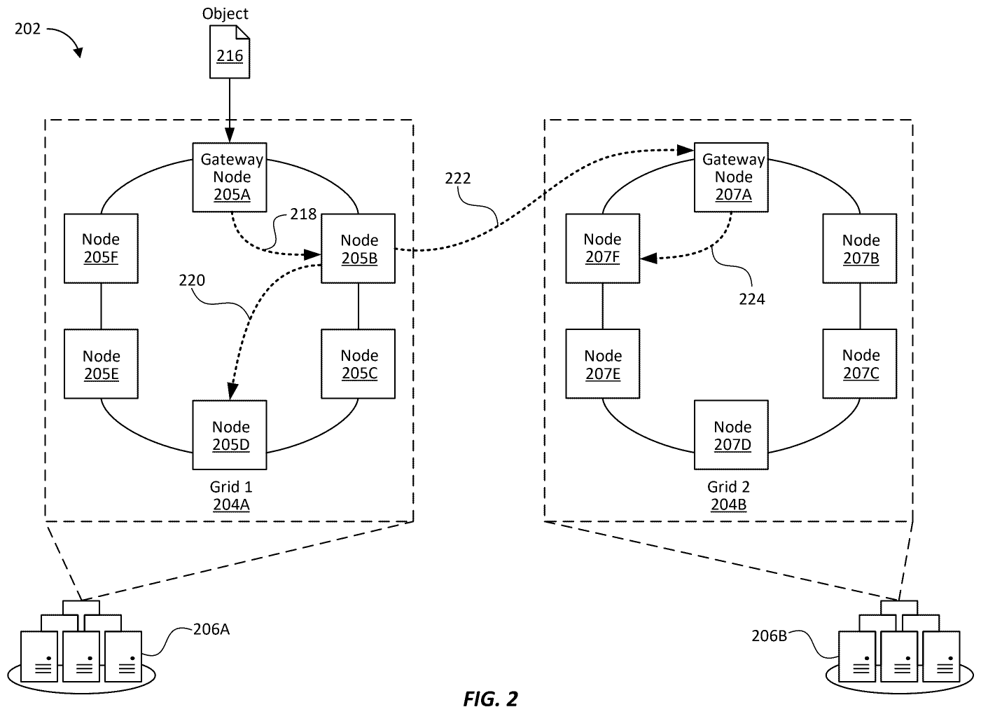

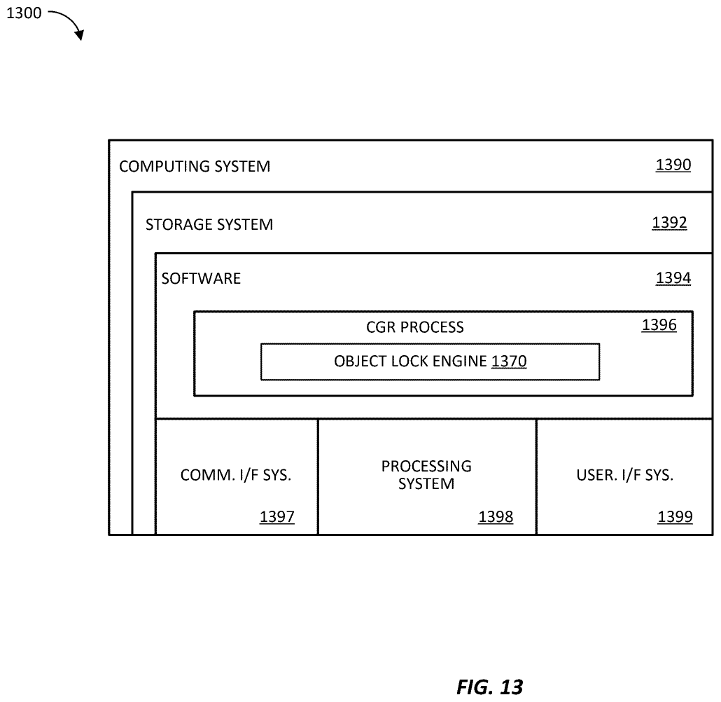

As will be described in greater detail below with respect to FIG. 2, each of the storage grids 104A and 104B include multiple nodes or servers 106A and 106B, respectively, each equipped with storage capacity, forming a decentralized architecture. The servers 106A and 106B may be co-located with respect to each other or distributed across one or more data centers. Example servers 106A and 106B include web servers, application servers, virtual or physical servers, or any combination thereof, of which computing apparatus 1390 in FIG. 13 is broadly representative.

As noted above, the distributed nature of the storage grids 104A and 104B allows for seamless expansion of storage capacity by adding more nodes or servers 106A and 106B to the network, ensuring the storage system 101 can handle growing data volumes without becoming a bottleneck. That is, the decentralized infrastructure provided by the distributed storage systems 102A and 102B allows for efficient management and storage of large volumes of data across the interconnected servers 106A and 106B. Unlike traditional centralized storage systems, where all data is stored in a single location, the distributed storage systems 102A and 102B distribute data across the servers 106A and 106B, providing increased scalability, fault tolerance, and performance. It should be appreciated that while FIG. 1 illustrates that the storage grids 104A and 104B as part of separate distributed storage systems 102A and 102B, in some cases the storage grids 104A and 104B may be part of the same distributed storage system.

As shown, the system 100 includes a storage application 112. The storage application 112 may act as an intermediary between the storage system 101 and the business application 108. That is, the interaction between the business application 108 and the storage system 101 involves a structured process to store and manage data efficiently. When a user, such as a user of the client device 110, interacts with the business application 108, creating, modifying, or retrieving data, the storage application 112 communicates with the storage system 101 to handle the underlying data storage operations. As such, the storage application 112 acts as an intermediary between the business application 108 and the storage system 101 to manage the seamless flow of data.

The client device 110 may communicate with the business application 108 and/or the storage application 112 via one or more internets and intranets, the Internet, wired and wireless networks, local area networks (LANs), wide area networks (WANs), or any other type of network or combination thereof. Examples of the client device 110 may include personal computers, tablet computers, mobile phones, gaming consoles, wearable devices, Internet of Things (IoT) devices, and any other suitable devices, of which computing apparatus 1390 in FIG. 13 is also broadly representative.

When data needs to be stored, the business application 108 sends a request 114A to the storage application 112, specifying the type of operation (e.g., create, update, delete) and the relevant data. The storage application 112 then processes this request and interacts with the storage system 101 to store the data. This interaction may involve utilizing the distributed storage system 102A (or the distributed storage system 102B), where data is replicated or distributed across multiple nodes or servers for redundancy and fault tolerance. Conversely, when the business application 108 needs to retrieve data, it communicates with the storage application 112, which in turn queries the storage system 101 to fetch the required information. This retrieval process ensures that the business application 108 has access to the most up-to-date and accurate data stored within the storage system 101.

Throughout this interaction, the storage application 101 plays a crucial role in translating the data storage needs of the business application 108 into operations that are executed within the storage system 101. This collaboration enables the business application 108 to effectively store, manage, and retrieve data, contributing to the overall functionality and reliability of the business application 108.

In some cases, the business application 108 communicates with the distributed storage system 102A (or the distributed storage system 102B) by initiating an Input/Output (I/O) request 114A. For example, when the business application 108 requires access to or modification of data stored within the distributed storage system 102A, the business application 108 formulates a specific I/O request 114A, encapsulating details such as the type of operation (read, write, update), the targeted data, and any additional parameters. The request 114A is then transmitted through a designated storage interface or API (Application Programming Interface), here the storage application 112, which serves as the conduit between the business application 108 and the distributed storage system 102A. The storage application 112 interprets the I/O request 114A and routes the request 114B to the appropriate nodes within the distributed storage system 102A, which may span across multiple servers 106A or locations in the storage grid 104A.

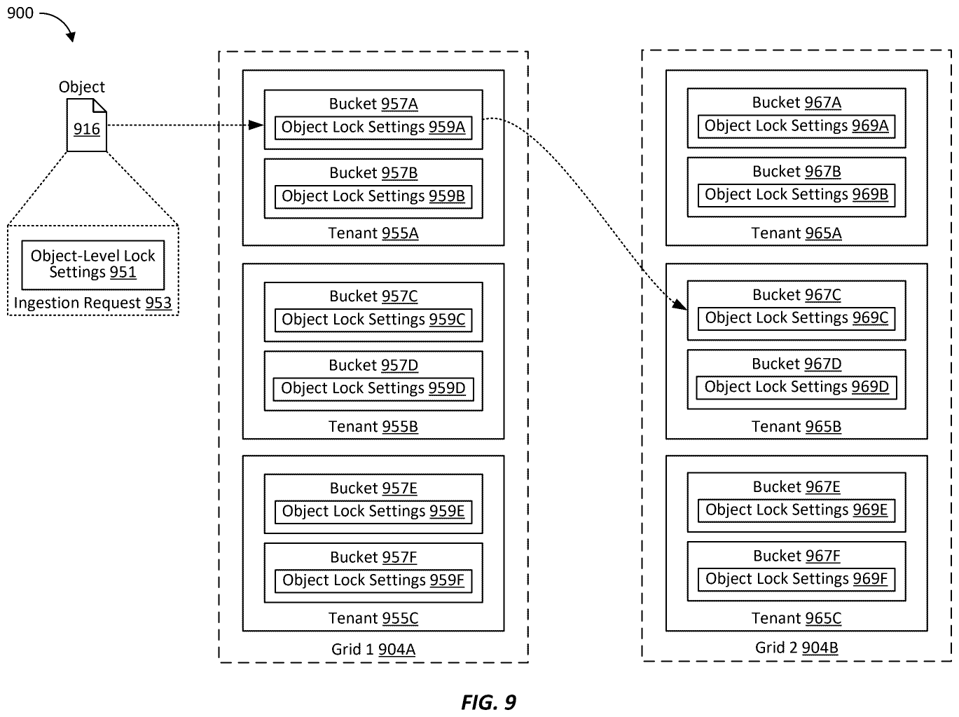

In the example where the I/O request 114A is to store an object (e.g., a document, image, video, or data), the storage grid 104A may perform one or more replication mechanisms to enable data redundancy and provide safeguards against hardware failures or other unforeseen events. As shown, when the I/O request 114A is received by the distributed storage system 102A, the storage grid 104A may perform a replication process 120 of the object within the storage grid 104A. That is, the replication process 120 may be an intra-grid replication process in which the object is ingested by the storage grid 104A and replicated (e.g., duplicate copies generated and stored) within the storage grid 104A upon ingest. The replication process 120 is described in greater detail below with respect to FIGS. 2-4. Moreover, as part of the replication process 120, the system can policy consistency across multiple storage grids as described in more detail in FIGS. 9-11.

In addition to the replication process 120, the storage grid 104A may also perform a cross-grid replication process 122, which replicates objects across the storage grids 104A-B within the distributed storage system 101. As will be described in greater detail below, the cross-grid replication process 122 may replicate the object to another storage grid, here, the storage grid 104B. This cross-grid replication enhances data durability and availability by maintaining copies of the object in geographically or logically separate grids 104A-B. By performing the cross-grid replication process 122, the storage system 101 enhances the object's resilience and fortifies against potential vulnerabilities. For example, by dispersing the replicated object between the storage grids 104A and 104B, the storage system 101 minimizes the risk and impact of localized failures or outages for the business application 108. That is, if the storage grid 104A suffers a failure, outage, or episodes of congestion, then the storage system 101 can provide the object that is replicated to the storage grid 104B to the business application 108. As those skilled in the art readily appreciate, the cross-grid replication process 122 ensures the integrity of the object and the availability of the object within the storage system 101.

Turning now to FIG. 2, an example distributed storage system 202 for providing cross-grid replication is illustrated, according to an embodiment herein. As shown, the distributed storage system 202, which may be the same or similar to the distributed storage systems 102A and/or 102B, includes two storage grids 204A and 204B, which may be the same or similar to the storage grids 104A and 104B. The storage grids 204A and 204B may be formed by servers 206A and 206B, respectively, which may be the same or similar to the servers 106A and 106B. As those skilled in the art readily appreciate, the servers 106A and 106B may collectively contribute to the organization and management of data across the storage grids 204A and 204B, respectively. In particular, the servers 206A and 206B may serve as nodes within the storage grids 204A and 204B, respectively, thereby collectively providing the essential building blocks that constitute the storage grids 204A and 204B. As shown, each of the storage grids 204A and 204B include multiple nodes. For example, the storage grid 204A includes nodes 205A-F and the storage grid 204B includes nodes 207A-F.

The nodes 205A-F and 207A-F may include software-based or hardware-based storage nodes or in Cloud Storage Pools (e.g., external S3 buckets or Azure Blob storage containers). The nodes 205A-F and 207A-F can manage and store object data and metadata. As such, these nodes 205A-F and 207A-F may include the services and processes that are required to store, move, verify, and retrieve object data and metadata on disk. The storage nodes run object services, metadata services, policy evaluators, and protocol services. Storage nodes can be spread across multiple data center sites.

Some or all of the nodes 205A-F and 207A-F may include various services (e.g., software modules) that provide various functionality and capabilities to the node. Examples of services that may be included on various nodes include, an information lifecycle management service to manage data policies, authentication services to authenticate tenants, load balancing services, and the like. It should be appreciated that while only six nodes 205A-F and six nodes 207A-F are illustrated for the storage grids 204A and 204B, respectively, any number of nodes 205A-F and 207A-F may be included in each of the storage grids 204A and 204B. Additionally, although the distributed storage system 202 is illustrated as including two storage grids 204A and 204B, the distributed storage system 202 may include any number of storage grids 204A and 204B.

Each of the nodes 205A-F may serve a distinct function within the storage grid 204A, with some of the nodes 205A-F specializing in data storage, while others in data retrieval. Similarly, the nodes 207A-F may serve various functions within the storage grid 204B. In particular, the nodes 205A and 207A may be gateway nodes that serve as a crucial interface between the storage grids 204A and 204B, respectively, an external networks or applications, such as the business application 108. The gateway nodes 205A and 207A may be used to balance ingestion and retrieval workloads. In some cases, the gateway nodes 205A and 207A provide a dedicated load-balancing interface that S3 client applications can use to connect to a grid. As gateway nodes, the nodes 205A and 207A manage the ingress and egress of objects, such as an object 216, handling requests from external sources, and ensure that objects are seamlessly ingested by the storage grids 204A and 204B, respectively.

While not illustrated in FIG. 2, there may be administrative (“admin”) nodes in addition to the gateway nodes 205A and 207A and storage nodes 205B-F and 207B-F. The admin nodes can be designed to provide management services such as system configuration, monitoring, and logging. The admin nodes can be used to load balance S3 client traffic. The load balancer service can be provided on admin nodes and gateway nodes to perform Transport Layer Security (TLS) termination of client requests, inspect the requests, and establish new secure connections to the storage nodes. The load balancer service seamlessly directs clients to an optimal storage node so that the failure of nodes or even an entire site is transparent. In some embodiments, high-availability (HA) groups can be created from network interfaces on admin nodes and gateway nodes so that access to data and management functions is not disrupted. In addition, traffic classification policies can be created to monitor and—optionally—limit network traffic. The traffic classification policies can be applied to specific buckets and tenants. After traffic has been classified, optional limits on the traffic class can be set.

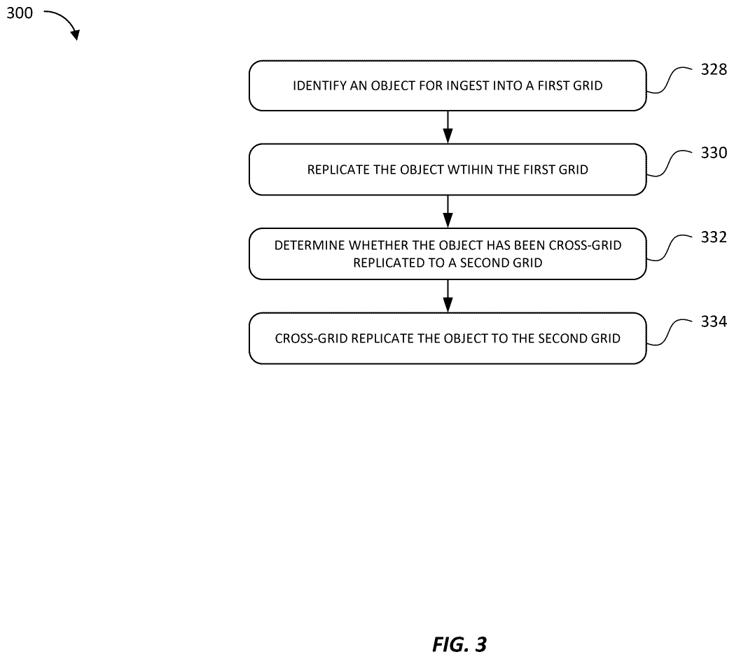

For ease of illustration, the remaining discussion of FIG. 2 is made with reference to FIG. 3. FIG. 3 provides a process 300 for performing cross-grid replication, according to an embodiment herein. While the process 300, which may be referred to herein as a cross-grid replication process, is described with respect to FIG. 2, it should be appreciated that it is equally applicable to other systems and components provided herein. Additionally, while the process 300 illustrates steps 328, 330, 332, and 334, the process 300 is not limited to these steps and may include additional steps or may lack one or more of these steps. That is, the steps 328-334 are provided to illustrate the cross-grid replication process, not limit it to these steps.

Returning now to FIG. 2, to begin the process 300, the object 216 may be identified for ingest into the storage grid 204A (328). In particular, the object 216 may be received from the storage application 112 working as an intermediary between the business application 108 and the distributed storage system 202. The business application 108 may have submitted an I/O request 114A for the distributed storage system 202 to save the object 216. While the following example is with respect to saving the object 216 within the distributed storage system 202, it should be appreciated that other operations of the object 216 are contemplated herein, such as retrieving the object 216, modifying the object 216, or sharing the object 216 with other client devices.

To ingest the object 216 into the distributed storage system 202, the gateway node 205A may initially receive the object 216. Specifically, the gateway node 205A may receive the object 216 through a data ingress process. Since the gateway node 205A serves as the entry point into the storage grid 204A, the gateway node 205A receives the object 216 and directs 218 the object 216, along with the associated save request from the business application 208, to an appropriate node within the storage grid 204A. As those skilled in the art readily appreciate, the gateway node 205A plays a central role in managing the overall data flow within the distributed storage system 202 by coordinating and distributing data based on the availability of the storage grid 204A.

Here, the gateway node 205A directs 218 the object 216, along with its associated save request, to the node 205B. The node 205B may be a storage node within the storage grid 204A. As indicated by its name, the storage node 205B stores and manages data within the distributed storage system 202. For example, the storage node 205B may be an individual server or computing system within the servers 206A that contributes to the overall storage capacity of the distributed storage system 202 and stores data, such as the object 216, as part of the ingest process. As will be described in greater detail below, in some embodiments, the gateway node 205A may direct the object 216 to the node 205B based on an assigned bucket or tenant associated with the object 216.

In addition to storing and managing data, the storage node 205B may also perform one or more data replication processes. As noted above, when the object 216 is initially ingested into the distributed storage system 202, in particular into the storage grid 204A, an intra-grid replication process 220 may be performed to replicate the object 216 within the storage grid 204A (330). By performing the intra-grid replication process 220, multiple replicates (e.g., copies, duplicates) of the object 216 may be generated and stored within the storage grid 204A. By having replicates of the object 216 within the storage grid 204A, the system 202 can ensure high availability and durability of the object 216 for the business application 108.

Although the intra-grid replication process 220 is illustrated as replicating the object 216 to the node 205D, it should be appreciated that the object 216 may be replicated to two or more nodes 205B-F within the storage grid 204A. For example, the object 216 may be replicated to the nodes 205C, 205D, and 205E via the intra-grid replication process 220. It should also be appreciated that while the ingesting node 205B is illustrated as performing the intra-grid replication process 220, non-ingesting nodes 205C-F may perform the intra-grid replication process 220, depending on the availability and capacity of the nodes 205B-F.

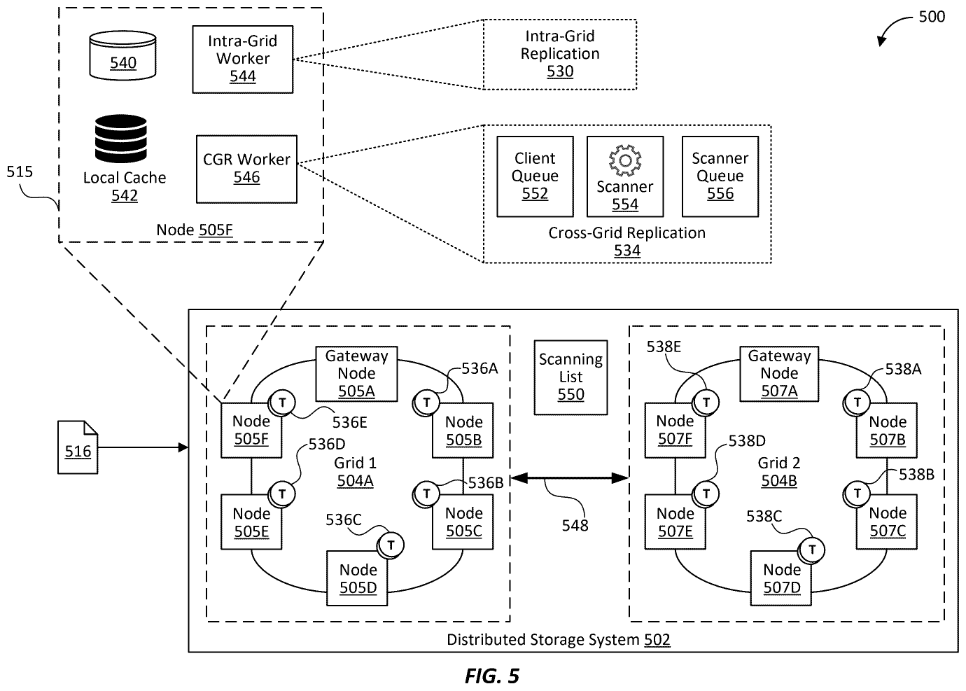

As noted above, relying solely on intra-grid replication 220 for data availability can leave a distributed storage system vulnerable to a variety of problems. To safeguard against these problems the distributed storage system 202 may include systems and processes to perform cross-grid replication. For example, in addition to performing the intra-grid replication process 220, the storage node 205B may also perform a cross-grid replication process 222 (334). Cross-grid replication may include replication (or enforcement) of one or more policies associated with the object. In some embodiments, to ensure that other nodes 205C-F within the storage grid 204A are not also performing the cross-grid replication process 222 for the object 216, the node 205B may first determine a cross-grid replication status (e.g., in-progress, completed, uninitiated) for the object 216 before performing the cross-grid replication process 222 (332). As will be described in greater detail below with respect to FIGS. 5-7, determining the cross-grid replication status of the object 216 may include, in some cases, checking a local cache of one or more of the nodes 205B-F to see if the cross-grid replication process 222 has been initiated. Table 1 provided below provides an illustrative example of a local cache for one of the nodes 205B-F indicating cross-grid replication status for each object ingested into the distributed storage system 202.

TABLE 1

| Object | Cross-Grid Replication Status |
|---|---|
| Object A | Completed |
| Object B | In-progress |
| Object 216 | Incomplete |

While the following discussion describes the storage node 205B performing the cross-grid replication process 222, it should be appreciated that other nodes within the storage grid 204A may perform the cross-grid replication process 222. That is, in the illustrated example, the storage node 205B is the ingesting node for the object 216 and is performing the cross-grid replication process 222, however, the node performing the cross-grid replication process 222 does not need to be the ingesting node. For example, the node 205D may perform the cross-grid replication process 222. Systems and processes used by the nodes 205B-F within the storage grid 204A to determine which node performs the cross-grid replication process 222 are described in greater detail below with respect to FIGS. 5-8.

When the storage node 205B performs the cross-grid replication process 222, the storage node 205B may establish a client connection with the storage grid 204B. Specifically, the storage node 205B may establish a client connection with the gateway node 207A of the storage grid 204B. The client connection, as used herein, refers to a communication link established between clients external to the gateway node 207A. Typically, external clients include the business application 108, however, via the cross-grid replication process 222, the storage node 205B acts as an external client when communicating with the gateway node 207A. As such, the client connection typically utilizes standard network protocols and communication methods, such as hypertext transfer protocol (HTTP).

The client connection established with the gateway nodes 205A and 207A, either from an external client such as the business application 108 or from a storage node on another storage grid via the cross-grid replication process 222, is distinct from the connections between nodes within the same storage grid. That is, the client connection established between the storage node 205B and the gateway node 207A is different than the internal connection between the storage node 205B and the other nodes 205A and 205C-F within the storage grid 204A. Similarly, the client connection established between the gateway node 207A and the storage node 205B is different than the internal connections between the gateway node 207A and the other nodes 207B-F within the storage grid 204B.

The client connection may differ from the internal connection between the nodes 205A-F within the storage grid 204A and the nodes 207A-F within the storage grid 204B at least by protocol. That is, the internal connection between nodes of the same storage grid may use specialized protocols that optimize efficient data replication and coordination, such as intern-node communication protocols specific to the distribute storage system 202 or even the storage grids 204A and/or 204B. In contrast, the client connection may use standard network protocols (e.g., HTTP, REST, or custom APIs) suitable for client-server communication over the internet.

The client connection may also differ from the internal connection between the nodes 205A-F within the storage grid 204A and the nodes 207A-F within the storage grid 204B by communication patterns. That is, the communication patterns involved in the internal connection between the nodes 204A-F and 207A-F and the client connections established by the gateway nodes 205A/207A embody distinct roles and functionalities. The nodes 205A-F and 207A-F engage in intricate, internal communication patterns, collaborating through peer-to-peer or client-server models to ensure tasks like data replication, synchronization, and load balancing. This inter-node communication is specialized, designed to optimize the storage grids 204A and 204B efficiency and data consistency. On the other hand, the communication pattern between the gateway node 205A/207B and external clients adheres to a client-server model, where clients initiate requests and the gateway node 205A/207A acts as an interface to the distributed storage system 202. This client-server interaction is characterized by standardized network protocols, facilitating seamless data ingress and egress between the external clients and the distributed storage infrastructure.

Once the storage node 205B establishes the client connection with the gateway node 207A, the gateway node 207A may direct 224 the cross-grid replication of the object 216 to the storage node 207F as part of the cross-grid replication process 222. Upon receipt, the storage node 207F may store the replicated object 216. As will be described in greater detail below, along with replicating the object metadata, applicable policies governing the object 216 may also be cross-grid replicated and applied to the object 216 as replicated and stored on the storage node 207F. Similar to the storage node 205B, the storage node 207F may be an individual server or computing system within the servers 206B that contributes to the overall storage capacity of the distributed storage system 202 and stores data, such as the replicated object 216.

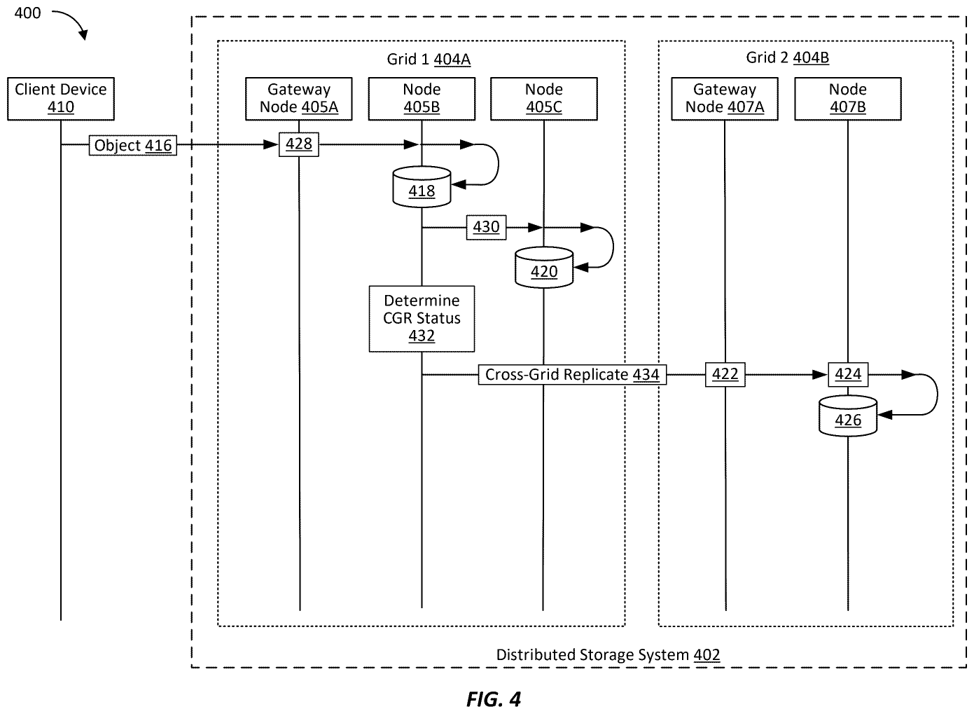

Referring now to FIG. 4, an example flow 400 for performing a cross-grid replication process, such as the process 300, is illustrated, according to an embodiment herein. As shown, a client device 410, which may be the same or similar to the client device 110 may submit a request to save, edit, or otherwise modify an object 416. The object 416, similar to the object 216, may be a discrete unit of data or information, such as a file, document, image, video, audio file, or any other digital content. In particular, the client device 410 may submit the request to a distributed storage system 402. The distributed storage system 402 may be the same or similar to the distributed storage system 202. As noted above, the client device 410 may submit its request to the distributed storage system 402 via an API, such as the storage application 112, which in some cases, coordinates with the business application 108 executing on the client device 410.

In the illustrated example, the distributed storage system 402 includes two storage grids 404A and 404B, which may be the same or similar to the storage grids 204A and 204B, respectively. As such, each of the storage grids 404A and 404B may include multiple nodes, such as the storage grid 404A including a gateway node 405A and storage nodes 405B and 405C. Similarly, the storage grid 404B may include a gateway node 407A and a storage node 407B. The request from the client device 410 and the object 416 associated with the request may be received by the storage grid 404A. In particular, the gateway node 405A of the storage grid 404A receives the object 416 and its associated request (428).

Based on the availability and assigned responsibility of the storage nodes within the storage grid 404A, the gateway node 405A directs or routes the object 416 and its associated request to the storage node 405B. Upon receipt of the object 416, the storage node 405B may save the object 416 (418). In addition to saving the object 416, the storage node 405B may also replicate the object 416 within the storage grid 404A (430). That is, the storage node 405B may determine one or more storage nodes 405C within the storage grid 404A to replicate the object 416 to. As part of the intra-grid replication process, the storage node 405C replicates and stores the object 416 (420).

In addition to intra-grid replicating the object 416, the storage node 405B may also determine whether to initiate a cross-grid replication process. To determine whether to initiate a cross-grid replication process, the storage node 405B may determine a cross-grid replication (CGR) status 432 of the object 416. As will be expanded on in greater detail below, determining the CGR status 432 of the object 416 may include checking with other storage nodes within the storage grid 404A to see whether any of the storage nodes have already initiated the cross-grid replication process. In addition to determining whether any other storage nodes have initiated the cross-grid replication process for the object 416, the storage node 405B may also determine whether it is responsible for cross-grid replicating the object 416. These aspects of the cross-grid replication process are described in greater detail below with respect to FIGS. 5-7.

If the storage node 405B determines that the CGR status 432 of the object 416 indicates that a cross-grid replication process of the object 416 has not yet been initiated, then the storage grid 404A may initiate a cross-grid replication process (434). To initiate the cross-grid replication process (434), the storage node 405B may establish a client connection with the gateway node 407A of the storage grid 404B. In some cases, establishing the client connection may include undergoing one or more authentication or validation processes.

Once the client connection is established between the storage node 405B and the gateway node 407A, the storage node 405B initiates cross-grid replication (422) of the object 416. The gateway node 407A may process the cross-grid replication (422) request received from the storage node 405B and direct the cross-grid replication (422) request to the storage node 407B (424). Responsive to receiving the cross-grid replication (424) request, the storage node 407B may replicate and store the replicated object 426.

Turning now to FIG. 5, an example operational system 500 for performing cross-grid replication is illustrated, according to an embodiment herein. In particular, the system 500 illustrates the cross-grid replication process at a node level within a distributed storage system 502. As shown, the distributed storage system 502, which may be the same or similar to the distributed storage system 202, includes two storage grids 504A and 504B, which may be the same or similar to the storage grids 204A and 204B, respectively.

As described above, each of the storage grids 504A and 504B may include multiple nodes having a variety of functions. For example, the storage grid 504A may include a gateway node 505A and storage nodes 505B-F, and the storage grid 504B may include a gateway node 507A and storage nodes 507B-F. While the discussion herein only includes the storage grids 504A and 504B including a gateway node and storage nodes, it should be appreciated that the storage grids 504A and 504B may include other types of nodes, such as metadata nodes, computational nodes, and coordination nodes. Additionally, while each of the storage grids 504A and 504B are illustrated as only including a single gateway node and five storage nodes, the storage grids 504A and 504B may include any number of gateway nodes and storage nodes. The limited number of nodes illustrated in the Figures are for ease of explanation.

Each of the storage nodes 505B-F and 507B-F may include various components for performing intra-grid replication and/or cross-grid replication. As illustrated by blowout view 515, the storage node 505F may include storage medium 540, a local cache 542, an intra-grid worker 544, and a cross-grid replication (CGR) worker 546. When an object is received by the distributed storage system 502, ingressed by the gateway node 505A, and directed to the storage node 505F for ingest, the storage node 505F may use one or more of these components to perform its functions for various ingestion and replication processes.

For example, when storage node 505F ingests an object 516, the storage node 505F may store the object 516 in the storage medium 540. As part of the ingest process, the storage node 505F may process and validate the data associated with the object 516. Additionally, the storage node 505F may prepare the object 516, along with its associated metadata, for storage in the storage medium 540. In some cases, the metadata may include object lock setting headers identifying governing policies applicable to the object 516, as described below. Accordingly, the storage medium 540 may be a local storage medium in which the storage node 505F stores objects, along with an object's associated metadata, as it is ingested. In an example, the storage medium 540 may include high-capacity hard disk drives (HDDs) or solid-state drives (SSDs). In other words, the storage medium 540 provides the physical storage space where object data, such as data associated with the object 516, is persistently stored, along with associated metadata. As those skilled in the art readily appreciate, the use of HDDs or SSDs allows for efficient and reliable data retrieval, with HDDs offering cost-effective high-capacity storage and SSDs providing faster access times, catering to the specific performance and capacity requirements of the distributed storage system 502.

As part of the ingest process, the storage node 505F may also intra-grid replicate the object 516 to one or more storage nodes 505B-505E within the storage grid 504A. To perform the intra-grid replication process, the storage node 505F may include the intra-grid worker 544. The intra-grid worker 544 may be an agent or component of the storage node 505F including software code or instructions for performing intra-grid replication 530 of ingested objects, such as the object 516. As part of the intra-grid replication 530, the intra-grid worker 544 generates duplicate copies (e.g., replicates) of the object 516 and identifies one or more storage nodes 505B-E for distribution of the replicates. The intra-grid replication 530 may occur simultaneously or sequentially with the local storage of the object 516 by the storage node 505F, depending on the architecture of the distributed storage system 502 and predefined strategies. The worker 544 may receive acknowledgments from the recipient storage nodes 505B-E confirming the successful replication of the object copies. Simultaneously, the metadata associated with the object 514 is updated to reflect its replication status and the location of the replicated copies.

The worker 544 may also communicate the completion of the intra-grid replication 530 to a coordinating component, providing a confirmation or acknowledgment. This communication ensures that the object 514 is not only stored locally on the storage node 505F but has been successfully replicated across one or more storage nodes 505B-E within the storage grid 504A. As noted above, the intra-grid replication 530 enhances data availability, fault tolerance, and resilience within the distributed storage system 502, safeguarding against potential node failures or other issues that may impact data accessibility.

The storage node 505F may also include the CGR worker 546 for performing cross-grid replication 534 of the object 516. The CGR worker may be an agent or component including software code or instructions for performing cross-grid replication 534 of the object 516. As described above, cross-grid replication 534 includes replicating the object 516 to another storage grid, such as the storage grid 504B. Although the storage grids 504A and 504B are illustrated as part of the same distributed storage system 502, in some cases, the storage grids 504A and 504B may be in separate distributed storage systems, such as is illustrated in FIG. 1.

Additionally, in some cases, the storage grids 504A and 504B may be co-located at the same physical location or distributed across different geographical locations. In the former scenario, multiple independent storage grids 504A and 504B may operate within the same data center or facility, ensuring localized data management. Alternatively, in a distributed setup, storage grids 504A and 504B may be strategically located at different physical locations, providing benefits such as geographical redundancy, disaster recovery capabilities, and improved data access for users distributed across various regions. The choice between co-locating or geographically dispersing the storage grids 504A and 504B depends on factors like performance requirements, data resilience needs, and the specific objectives of the distributed storage system 502.

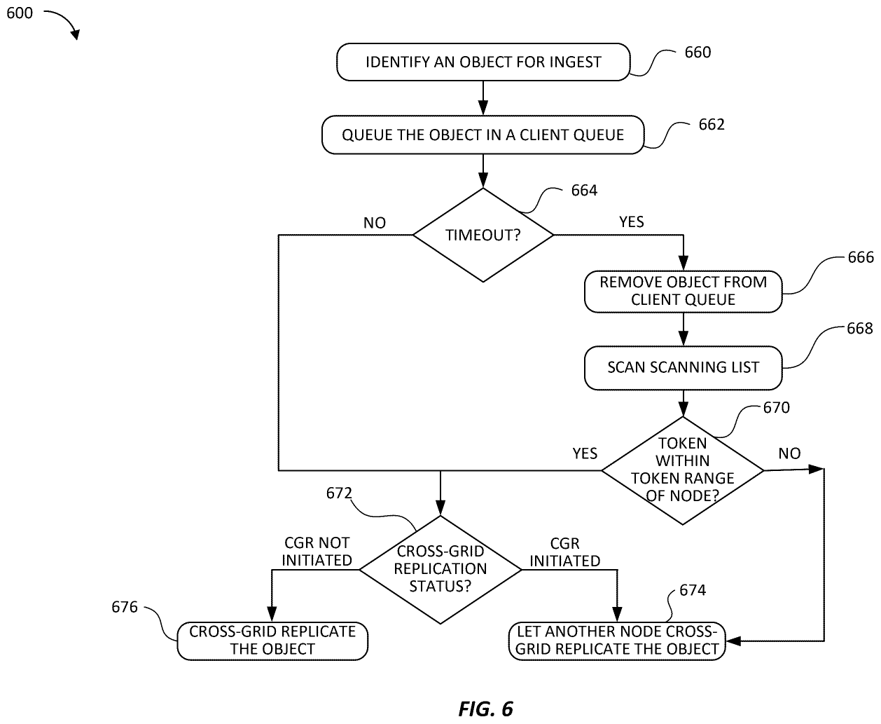

For ease of explanation, the remaining discussion of FIG. 5 is made with reference to FIG. 6. FIG. 6 illustrates an example cross-grid replication process 600, according to an embodiment herein. While the process 600 is described with respect to FIG. 5, it should be appreciated that it is equally applicable to other systems and components provided herein. Additionally, while the process 600 illustrates steps 660-676, the process 600 is not limited to these steps and may include additional steps or may lack one or more of these steps. That is, the steps 660-676 are provided to illustrate the cross-grid replication process, not limit it to these steps.

As described above, the process 600 may start with identifying the object 516 for ingest (660) by the storage node 505F. As part of the ingest process, the CGR worker 546 may add the object 516 to a client queue 552 (662). That is, simultaneously or sequentially to the intra-grid worker 544 receiving the object 516 for ingest and/or performing the intra-grid replication 530, the CGR worker 546 may place the object 516 on the client queue 552. The client queue 552 may be a queue of objects for the storage node 505F to cross-grid replicate 534. That is, the CGR worker 546 may cross-grid replicate 534 objects that are on the client queue 552.

However, there may be a high number of objects in the client queue 552 for cross-grid replication or an object on the client queue 552 may be large, thus tying up the storage node's 505F resources. To ensure that cross-grid replication is performed efficiently and swiftly, there may be a time limit for which an object, such as the object 516, can stay in the client queue 552. For example, the time limit may be 1 minute, 5 minutes, 10 minutes, or the like. When the time limit is met, the object 516 may timeout (664) and be removed from the client queue (666). In other words, the CGR worker 546 may monitor the time duration that the object 516 is on the client queue 552 and determine that a timeout has occurred (664) and remove the object 516 from the client queue 552 (666) based on the timeout.

When the object 516 is removed from the client queue 552, the object 516 may be placed on a scanning list 550. The scanning list 550 may be hosted by the distributed storage system 502 or each storage grid 504A and 504B may host their own respective scanning list 550. The scanning list 550 may include objects that have not yet been cross-grid replicated. In other words, the scanning list 550 may include objects that have been removed from the client queues 552 of the storage nodes 505B-F and/or the storage nodes 507B-F. In an example, the scanning list 550 may be a table hosted by a database management system, such as Apache Cassandra.

In some embodiments, the object 516 may be added to the scanning list 550 adjacently or simultaneously to being added to the client queue 552. In such a case, the object 516 may be added to the scanning list 550 prior to the determination of whether a timeout has occurred or not. Because the client queue 552 may be an in-memory data, adding the object 516 to the scanning list 550 simultaneously can serve as a failsafe since the scanning list 550 may be persisted in a durable form. For example, if a respective ingest node experiences a fault, the client queue 552 may be lost, thus adding the object 516 to the scanning list 550 in parallel to the client queue 552 can ensure that the object 516 is replicated and not lost in the fault.

To prevent multiple storage nodes 505B-F from cross-grid replicating 534 the object 516, each of the storage nodes 505B-F may include a scanner 554. The scanner 554 may scan the scanning list 550 to identify objects 516 that a respective node is responsible for cross-grid replicating. For example, the storage node 505F includes the scanner 554 that scans the scanning list 550 for the object 516 that it is responsible for cross-grid replicating.

As noted above, the storage node 505F may determine the CGR status of the object 516 before cross-grid replicating the object 516. This determination includes checking to make sure whether or not other storage nodes 505B-E have already initiated the cross-grid replication process. In other words, checking the CGR status of the object 516 ensures that only a single duplicate copy of the object 516 is cross-grid replicated.

Cross-grid replication of the object 516, when performed multiple times or by multiple storage nodes 505B-F, can introduce several challenges, with race conditions being a prominent concern. In scenarios where the same object 516 is replicated across the storage grids 504A and 504B simultaneously, conflicts may arise due to the asynchronous nature of replication processes. Race conditions occur when conflicting updates or changes are made to the object 516 during the replication process, leading to inconsistencies in replicated copies. This can result in a lack of synchronization among the storage grids 504A and 504B, compromising data integrity. Additionally, the potential for increased network traffic and resource utilization arises as multiple replication processes contend for bandwidth and processing resources. As such, the cross-grid replication process 600 and the CGR worker 546 provided herein, provide an enhanced cross-grid replication process that manages conflicts, ensures consistency, minimizes the impact of race conditions, and ultimately maintains a coherent and reliable distributed storage system 502.

To prevent multiple storage nodes 505B-F from performing the cross-grid replication process on the same object 516, each storage nodes 505B-F may be assigned a token range 536A-E. For example, the node 505B may be assigned the token range 536A, the node 505C may be assigned the token range 536B, the node 505D may be assigned the token range 536C, the node 505E may be assigned the token range 536D, and the node 505F may be assigned the token range 536E. The token ranges 536A-E may be assigned to each of the storage nodes 505B-F via a sharding process. As those skilled in the art readily appreciate, a sharding process may entail the systematic assignment of token ranges 536A-E to individual storage nodes 505B-F, serving as a fundamental mechanism for data partitioning and responsibility distribution. Sharding is particularly crucial in systems like Apache Cassandra to enable horizontal scalability and efficient data retrieval.

During the sharding process, the distributed storage system 502 employs a consistent hashing algorithm to generate tokens representing ranges of data. As such, upon ingest of the object 516, the object 516 may be assigned a token. These tokens are then mapped to the storage nodes 505B-F in the distributed storage system 502 as the assigned token ranges 536A-E to ensure that each node is responsible for specific token ranges. This approach not only distributes the cross-grid replication responsibility evenly across the nodes 505B-F but also facilitates a balanced and scalable architecture. The sharding process enhances fault tolerance and parallelizes data operations, as each storage node 505B-F is independently responsible for its assigned token range, contributing to the overall efficiency and performance of the distributed storage system 502. As illustrated, each of the storage nodes 507B-F in the storage grid 504B may similarly be assigned a respective token range 538A-E.

Returning now to the scanner 554, the scanner 554 may scan the scanning list 550 (668) to identify objects 516 that have a token within the token range 536A of the storage node 505F (670). If the scanner 554 identifies the object 516 as having a token within the token range 536E of the storage node 505F, then the CGR worker 546 may move the object 516 from the scanning list 550 to the scanning queue 556. The scanning queue 556 may be a queue or list of all the objects 516 that the storage node 505F is responsible for cross-grid replicating.

Once on the scanning queue 556, the CGR worker 546 may determine the CGR status (672) of the object 516 prior to initiating the cross-grid replication of the object 516. This determination may be made once the object 516 reaches the top of the scanning queue 556 or as the object 516 approaches the top of the scanning queue 556. The top of the scanning queue 556, as used herein, may refer to the object's 516 position in the scanning queue 556 indicating that it is the object's 516 turn to be cross-grid replicated.

To determine the CGR status of the object 516, the storage node 505F may check its local cache 542 to determine whether cross-grid replication of the object 516 was already initiated. There may be scenarios where the storage node 505F initiated cross-grid replication of the object 516 while the object 516 was on the client queue 552. However, due to the size of the object 516 or the timing of when the cross-grid replication process was initiated, the object 516 may have timed-out of the client queue 552 and been removed to the scanning list 550. Thus, the storage node 505F may have initiated the cross-grid replication process and such process may be underway or even completed by the time the object 516 is moved to the scanner queue. As such, checking the CGR status of the object 516 prior to initiating the cross-grid replication based on the object 516 being in the scanner queue 556 ensures that the object 516 is not cross-grid replicated twice.

In embodiments, the storage node 505F may check with (e.g., send a query to) the other storage nodes 505B-E, specifically requesting the nodes check their local caches, to confirm that cross-grid replication of the object 516 has not yet been initiated. For example, if the object 516 was ingested by the storage node 505B, then the storage node 505B may have placed the object 516 on its client queue 552. While on the client queue 552, the storage node 505B may have initiated the cross-grid replication of the object 516. However, due to the object's 516 size or the timing of the cross-grid replication process, the object 516 may have timed-out and been removed to the scanning list 550. In this example, the object 516 may have a token that is within the token range 536E of the storage node 505F, not the token range 536A of the storage node 505B. As such, the storage node 505F may identify the object 516 as within its token range 536E and move it to its scanner queue 556. By checking with the other storage nodes 505B-E, in particular the storage node 505B, the storage node 505F can determine that the storage node 505B already initiated (or even completed) the cross-grid replication of the object 516 and let the storage node 505B replicate the object 516 (674). In other words, the storage node 505F, upon determining that cross-grid replication of the object 516 has already been initiated by another storage node, can refrain from cross-grid replicating the object 516 and remove the object 516 from the scanner queue 556.

In the alternative, if the storage node 505F determines that cross-grid replication of the object 516 has not been initiated by any other storage nodes 505B-E or itself, then the storage node 505F can proceed with cross-grid replication the object 516 (676), as described above. For example, the storage node 505F may establish a client connection 548 with the gateway node 507A of the storage grid 504B and transmit a request that the object 516 is cross-grid replicated to the storage grid 504B.

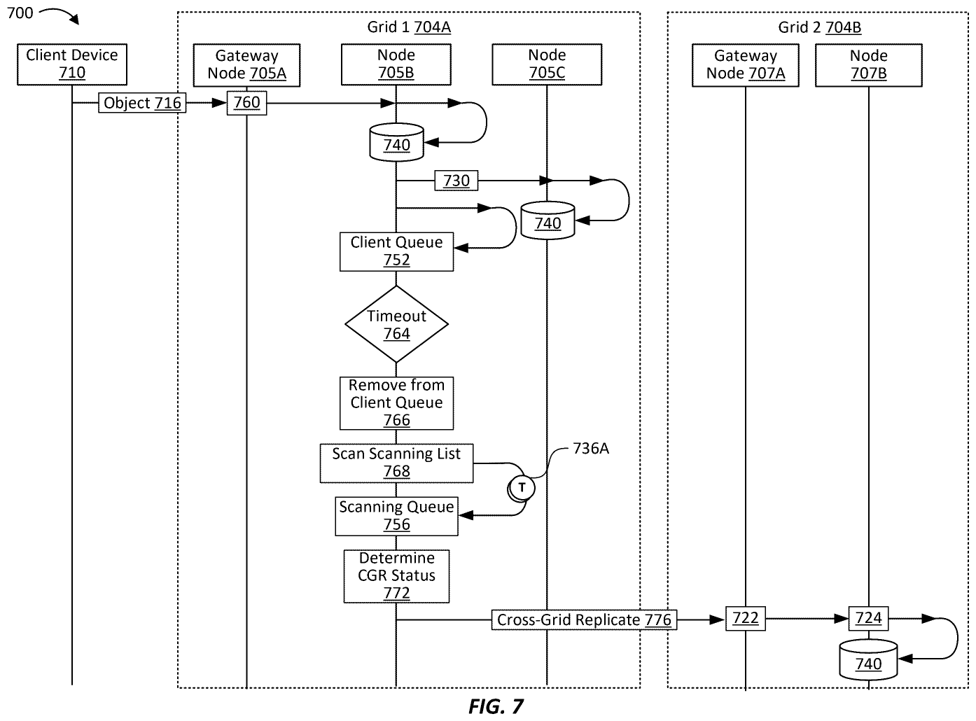

Turning now to FIG. 7, an example flow 700 of a cross-grid replication process is illustrated, according to an embodiment herein. As shown, a client device 710, which may be the same or similar to the client device 110 may submit a request to save, edit, or otherwise modify an object 716, which may be the same or similar to the object 516. In particular, the client device 710 may submit the request to the storage grid 704A via a distributed storage system (not shown). As described above, the client device 710 may submit its request to the distributed storage system, such as the distributed storage system 502, via an API, such as the storage application 112, which in some cases, coordinates with the business application 108 executing on the client device 710.

In the illustrated example, the distributed storage system includes two storage grids 704A and 704B, which may be the same or similar to the storage grids 504A and 504B, respectively. As such, each of the storage grids 704A and 704B may include multiple nodes, such as the storage grid 704A including a gateway node 705A and storage nodes 705B and 705C. Similarly, the storage grid 704B may include a gateway node 707A and a storage node 707B. As shown, the request from the client device 710, including the object 716 associated with the request is received by the storage grid 704A. In particular, the gateway node 705A of the storage grid 704A receives the object 716 and its associated request.

When the gateway node 705A receives the object 716, a respective storage node, such as the storage node 705B, within the storage grid 704A may identify the object 716 for ingest (760). As described above, the storage node that is assigned to ingest the object 716 may be determined by the gateway node 705A based on a variety of factors. When the storage node 705B is identified as the ingest node for the object 716, the gateway node 705A directs the object 716 to the storage node 705B. Upon receipt of the object 716, the storage node 705B may locally store the object 716 (depending on the request associated with the object 716) in a respective storage medium 740. The storage medium 740 may be the same or similar to the storage medium 540.

At the same time or shortly after the storage node 705B stores the object 716 in the storage medium 740, the storage node 705B may perform one or more intra-grid replication processes (730). In particular, an intra-grid worker, such as the intra-grid worker 544, of the storage node 705B may replicate the object 716 to one or more storage nodes 705C in the storage grid 704A. As illustrated, the storage node 705B may intra-grid replicate the object 716 (730) to the storage node 705C. Upon receipt of the replicated object 716, the storage node 705C may store the replicated object 716 on its respective storage medium 740.

As part of the ingest process, the storage node 705B may also add the object 716 to its client queue 752, which may be the same or similar to the client queue 552. In particular, a CGR worker may add the object 716 to the client queue 752 at the same time that the intra-grid worker performs the intra-grid replication (730) of the object 716. In some cases, the client device 710 may receive a “success” response from the storage grid 705B after the object 716 is added to the client queue 752 (not shown). At a subsequent point, the storage node 705B may determine that timeout 764 has occurred for the object 716. As described above, the timeout 764 may indicate that the amount of time that the object 716 has been on the client queue 752 has reached a time limit and therefore it is time to remove the object 716 from the client queue 752. Once the timeout 764 is determined, the CGR worker of the storage node 705B may remove the object 716 from the client queue 752 (766).

As described above, when the object 716 is removed from the client queue 752, the object 716 may be added to a scanning list of the storage grid 704A, such as the scanning list 550. As noted above, in some cases the object 716 may be added to the scanning list adjacent to being added to the client queue 752. Once on the scanning list 550, scanners for each respective storage node 705B-C may scan the scanning list 550 (768) to determine if any objects having tokens within a respective token range are on the list. In other words, the storage node 705B scans the scanning list to identify object's having tokens that fall within a token range 736A of the storage node 705B. If the storage node 705B identifies the object 716 (or any other objects) having tokens within the token range 736A, the storage node 705B adds the object 716 to its scanning queue (756).

Once on the scanning queue, the object 716 is identified by the storage node 705B for cross-grid replication. However, to prevent multiple storage nodes 705B-C on the storage grid 704A from cross-grid replicating the same object 716, the storage node 705B may first determine a cross-grid replication (CGR) status 772 of the object 716 before performing cross-grid replication. As described above, determining the CGR status 772 of the object 716 may include checking its own local cache (e.g., 542) or checking with the other storage nodes 705C on the storage grid 704A to confirm that they have not initiated cross-grid replication of the object 716. If the storage node 705B determines that cross-grid replication of the object 716 has already been initiated, either by itself or by another storage node 705C within the storage grid 704A, the storage node 705B may remove the object 716 from the scanning queue 756 and refrain from cross-grid replicating the object 716 again.

If the storage node 705B, however, determines that cross-grid replication of the object 716 has not yet been initiated, then the storage node 705B may initiate cross-grid replication of the object 716 (776). As part of the cross-grid replication process, the storage node 705B may establish a client connection with the gateway node 707A. Once the client connection is established between the storage node 705B and the gateway node 707A, the storage node 705B initiates cross-grid replication (776) of the object 716 to the gateway node 707A. The gateway node 707A may process the cross-grid replication (722) request received from the storage node 705B and direct the cross-grid replication (722) request to the storage node 707B (724). Responsive to receiving the cross-grid replication (722) request, the storage node 707B may replicate and store the replicated object in its respective local storage medium 740.

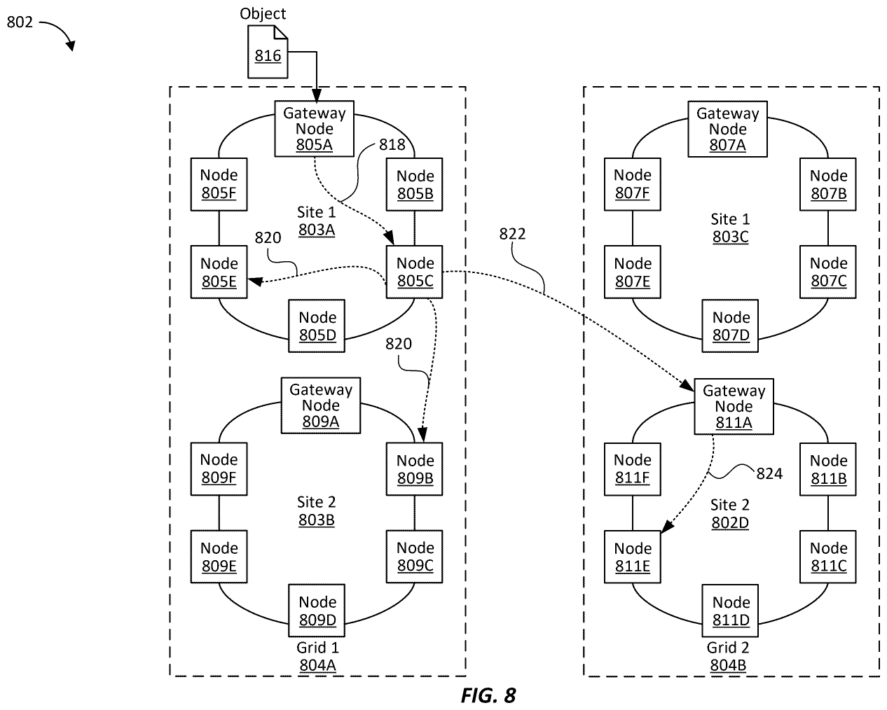

Turning now to FIG. 8, an example distributed storage system 802 having multiple dispersed storage grids is illustrated, according to an embodiment herein. As shown, the distributed storage system 802 includes multiple storage grids 804A and 804B, which may be the same or similar to the storage grids 504A and 504B. Each of the storage grids 804A and 804B may be dispersed across two or more sites. For example, the storage grid 804A is dispersed across a site 803A and a site 803B and the storage grid 804B is dispersed across a site 803C and a site 803D. Each of the sites 803A-D may be physically remote from one another. In some cases, however, one or more of the sites 803A-803D may be co-located with respect to one another, such as in the same location or data center.

As shown, each of the storage grids 804A and 804B may include multiple nodes, having various functions. For example, the storage grid 804A includes a gateway node 805A and storage nodes 805B-F at site 803A and a gateway node 809A and storage nodes 809B-F at site 803B. Similarly, the storage grid 804B includes a gateway node 807A and storage nodes 807B-F at site 803C and a gateway node 811A and storage nodes 811B-F at site 803D.

The distributed storage system 802 may include systems and processes for performing one or more functions of the cross-grid replication process described herein. For example, when an object 816 is received by the distributed storage system 802, the object 816 is received by the gateway 805A and directed (818) to the storage node 805C for ingest. As part of the ingest process, the storage node 805C performs intra-grid replication (820) of the object 816 to one or more storage nodes within the storage grid 804A. In the illustrated example, the storage node 805C intra-grid replicates (820) the object 816 to another storage node 805E at the site 803A and intra-grid replicates (820) the object 816 to the storage node 809B at the site 803B. Since the sites 803A and 803B are remote from one another, having replicated copies of the object 816 across the two sites enhances the data reliance of the object 816, disaster recovery capabilities, and provides improved access to the object 816 for users distributed across various regions.

In addition to intra-grid replicating (820) the object 816, the storage grid 805C may also cross-grid replicate (822) the object, as described above. When cross-grid replicating (822) the object 816, the storage node 805C may establish a client connection with the gateway node 811A of the storage grid 804B and initiate the cross-grid replication (822) process. As described above, the gateway node 811A may direct the replication request (824) to a respective storage node 811E, which in turn replicates and stores the replicated object 816.

As noted above, the cross-grid replication process described herein also addresses management of policies to replicated objects within a distributed storage system. That is, the cross-grid replication processes provided herein include replicating the object data itself as well as any applicable governing policies, such as object lock settings. Since storing objects in a storage grids includes more than just the object itself, replicating the object includes a cross-grid replication process that manages policies (e.g., object lock settings), before and during object replication. In other words, in addition to transferring object data between nodes across separate grids, the cross-grid replication process ensures that object lock settings governing objects prior to, during, and after replication remain consistent.

As previously noted, managing and consistently applying policies to objects throughout the replication process presents technical challenges that conventional approaches often overlook. Ensuring that policies, including object lock settings, are accurately replicated helps prevent data protection issues that may arise from policy inconsistencies. Failure to apply policies consistently can result in replicated objects lacking intended protections or becoming inaccessible when needed. Furthermore, inconsistencies in policy enforcement may contribute to replication failures or misconfigurations, potentially compromising data integrity and compliance. Therefore, effective management of applicable policies during cross-grid replication ensures that replicated data remains secure and protected within a distributed storage system.

Referring now to FIG. 9, an example logical architecture 900 of a distributed storage system is illustrated, according to an embodiment herein. The example logical architecture 900 is described with respect to FIG. 8, however, it should be appreciated that the following description is equally applicable to the systems and components provided herein. The logical architecture 900 defines the logical framework that governs how objects are managed and accessed within the grids 804A and 804B. That is, the storage nodes 805B-F, 807B-F, 809B-F, and 811B-F serve as the physical infrastructure responsible for storing and transferring objects, such as the object 816, within the distributed storage system 802, the logical architecture 900 provides the abstraction layer that dictates how the objects are organized, accessed, and controlled.

As illustrated, the grids 904A and 904B, which may be the same or similar to the grids 804A-B, include multiple tenants 955A-C and 965A-C. That is, the first grid 904A includes tenants 955A-C and the second grid 904B includes the tenants 965A-C. The tenants 955A-C and 965A-C each represent logically isolated entities within the distributed storage system 802, responsible for managing its own object storage resources, including buckets, access controls, and applicable policies. While the tenants 955A-C and 965A-C provide a logical structure for organizing and controlling object data, the storage nodes 805B-F, 807B-F, 809B-F, and 811B-F provide the physical infrastructure that stores and transfers the objects. That is, the tenants 955A-C and 965A-C govern how the storage nodes 805B-F, 807B-F, 809B-F, and 811B-F distribute and manage objects.

In the illustrated example, the tenants 955A-C may govern object data stored on the storage nodes 805B-F and 809B-F, and the tenants 965A-C may govern object data stored on the storage nodes 807B-F and 811B-F, regardless of the geographical location of the respective nodes. In some cases, a tenant's 955A-C (or 965A-C) governance may extend across multiple storage nodes 805B-F and 809B-F (or 807B-F and 811B-F) within the grid 904A (or 904B), meaning that object data belonging to a single tenant may be distributed across different physical locations while being managed under a unified logical structure. For example, the tenant 955A may manage object data stored across multiple of the storage nodes 805B-F and 809B-F, ensuring consistent application of storage policies, access controls, and object lock settings, irrespective of the physical location of the respective nodes. This abstraction allows the tenants 955A-C (965A-C) to enforce data governance uniformly across the distributed storage system 802, optimizing availability, redundancy, and compliance with applicable policies.

In some embodiments, a single storage node 805B-F and 809B-F (807B-F and 811B-F) may store object data for multiple tenants 955A-C (965A-C) in a single grid, enabling efficient resource utilization within the grid 904A (904B). For instance, the storage node 805B may contain objects belonging to multiple tenants in the first grid 904A, such as 955A and 955B, while ensuring strict logical isolation between their respective data. This multi-tenancy capability allows the distributed storage system 802 to support multiple users or business units within the same infrastructure while maintaining independent authentication, authorization, and storage policies for each tenant 955A-C (965A-C).

In some embodiments, the tenants 955A-C and 965A-C may include one or more buckets 957A-F or 967A-F, respectively. Each of the buckets 957A-F (967A-F) is a logical storage container within a respective tenant 955A-C (965A-C) that organizes and manages objects. Each bucket 957A-F (967A-F) may be uniquely named within the tenant's 955A-C (965A-C) namespace and serves as a primary mechanism for storing, retrieving, and applying policies to objects. For example, the buckets 957A-F (967A-F) may define attributes of the objects associated with a respective bucket, such as access control settings, lifecycle policies, replication configurations, including cross-grid replication, and the like.

Within the grid 904A (904B), the buckets 957A-F (967A-F) are logically associated with one of the tenants 955A-C (965A-C) but physically distributed across multiple storage nodes 805B-F and 809B-F (807B-F and 811A-F). This distribution allows the distributed storage system 802 to balance storage efficiency, redundancy, and performance based on Information Lifecycle Management (ILM) policies. A single tenant 955A-C (965A-C) may manage multiple buckets 957A-F (967A-F), each configured with different replication, retention, or encryption settings, depending on the data requirements.

Additionally, a single storage node 805B-F and 809B-F (807B-F and 811B-F) may store object data from multiple buckets 957A-F (967A-F) belonging to different tenants 955A-C (965A-C), ensuring optimal resource utilization within the grid 904A (904B). Despite sharing physical infrastructure, strict logical isolation between tenants 955A-C (965A-C) and buckets 957A-F (967A-F) ensures secure multi-tenancy, enforcing access control and preventing unauthorized cross-tenant data access. By leveraging this architecture, the distributed storage system 802 enables scalable, policy-driven data management while maintaining robust security and compliance standards.

As noted above, the buckets 957A-F (967A-F) may define various attributes for the objects stored within them, including access control settings, legal hold governance, and lifecycle policies, collectively referred to as object lock settings. The object lock settings enforce data immutability, retention policies, and regulatory compliance by defining rules on how objects can be accessed, modified, or deleted. In some embodiments, the object lock settings include a retention mode, which determines the level of access control applied to an object. For instance, the retention mode may include a governance mode and/or a compliance mode. The governance mode allows privileged users, such as administrators with specific permissions, to override the lock and delete or modify objects before the retention period expires. The governance mode provides flexibility while ensuring compliance with internal policies. In contrast, the compliance mode enforces strict immutability, preventing any user, including administrators, from altering or deleting an object until the retention period has expired. The compliance mode ensures adherence to stringent regulatory requirements by guaranteeing absolute data integrity. The following Table 2 illustrates some common examples of policies with object lock settings and their corresponding retention mode.

TABLE 2

| | | Retention |
|---|---|---|
| Policy | Description | Mode |
| Backup | Ensures data is not deleted or | Governance |
| | altered | mode |
| Ransomware | Ensures data is not deleted or | Governance |
| | altered by malicious attacks | mode |
| Regulatory | Ensures data is unaltered to meet | Compliance |
| Compliance | regulatory/legal requirements | mode |
| Legal Hold | Ensures preservation of data for | Compliance |
| | legal proceedings | mode |
| Data | Ensures integrity of data, | Governance |
| Integrity | especially critical data | Mode |
| Audit and | Ensure availability of unaltered | Compliance |
| Compliance | data for audits | Mode |

The object lock settings may also define a retention period of an object, which specifies how long the object must be preserved before it becomes eligible for deletion. The retention period ensures that the object remains immutable for a predefined time period, preventing any modifications or deletions until the specified expiration. Similar to the retention mode(s), the retention period may be configured at the object level in some embodiments, allowing for granular enforcement of the object lock settings tailored to specific data governance needs.

Additionally, the object lock settings may include a legal hold status, which places an indefinite retention hold on the object, preventing deletion until the legal hold is explicitly removed. Unlike the retention period, which has a defined expiration period, a legal hold remains in effect until manually lifted, ensuring that objects subject to legal review, litigation, or regulatory investigation remain preserved regardless of standard retention policies. By leveraging the object lock settings, organizations can enforce comprehensive data protection, regulatory compliance, and governance control within the multi-tenant, distributed storage system 802.

As noted above, managing object lock settings prior to and during cross-grid replication within the multi-tenant, distributed storage system 802 presents numerous challenges. Ensuring consistency of object lock settings across grids 904A-B is complex due to variations in regulatory requirements, tenant-specific configurations, and storage policies, which may differ between the separate grids 904A-B. Latency and replication timing introduce further complications, as changes to an object's retention period, legal hold status, or access policies (e.g., the object lock settings) at the source may not be immediately reflected at the destination, potentially leading to inconsistencies in governance enforcement. Additionally, object versioning and metadata synchronization must be carefully managed to prevent conflicts when an object is modified or deleted at one grid while replication is still in progress. Moreover, tenant-level isolation and access control enforcement present challenges, particularly when replicated objects must retain their original governance attributes while ensuring that cross-grid replication does not inadvertently override another tenant's security policies or violate data sovereignty constraints.

These issues are further compounded in scenarios where replicated objects must comply with different jurisdictional retention laws applicable to the geographically dispersed nodes 805A-F, 809A-F, 807A-F, and 811A-F, requiring careful reconciliation of the object lock settings across the grids 904A-B to prevent compliance violations. For example, a multinational enterprise may utilize a distributed storage system comprising two storage grids: the grid 904A, located in Germany, and the grid 904B, located in the United States. Each of the grids 904A-B include multiple geographically dispersed storage nodes (e.g., nodes 805A-F, 807A-F, 809A-F, and 811A-F). The enterprise stores financial records that are subject to jurisdiction-specific data retention and immutability laws. In Germany, regulations such as the GoBD, along with the EU's General Data Protection Regulation (GDPR), may require certain financial records to be retained in a write-once-read-many (WORM) state for a minimum of ten years, with strict prohibitions against modification or deletion. In contrast, U.S. regulations—such as SEC Rule 17a-4 (f) —may mandate a similar WORM format but with different retention durations and administrative control requirements.

Thus, if an object is ingested into the grid 904A with a ten-year lock and then replicated to the grid 904B through a cross-grid replication process, the system must reconcile the object lock settings to ensure compliance with both regulatory regimes. If the grid 904B enforces a shorter retention policy (e.g., seven years) or permits administrative overrides not allowed under German law, this inconsistency could result in a compliance violation. To prevent such risks, the storage system must coordinate and apply the most restrictive object lock settings across all grids, thereby ensuring regulatory compliance across jurisdictions and minimizing the risk of inadvertent policy breaches.

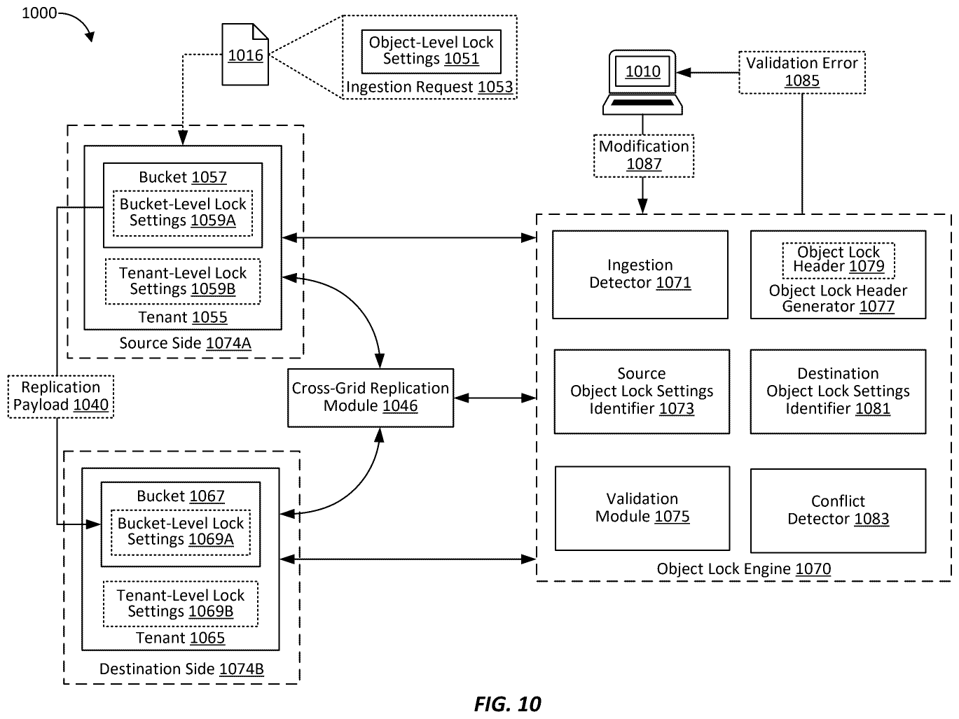

To manage the object lock settings for objects ingested into the distributed storage system 802, prior to, during, and after cross-grid replication, an object lock engine is provided herein. As will be described in greater detail below with respect to FIGS. 10-12, the object lock engine may manage the object lock settings for an object, such as the object 916. The object 916, which may be the same or similar to the object 816, may be ingested into the distributed storage system 802 as described above. In particular, the object 916 may be ingested into the distributed storage system 802 via a gateway node, such as the gateway node 805A, on the first grid 904A. The gateway node may direct the object 916 to a storage node, such as storage node 805C for ingestion.

In some embodiments, the gateway node directs the object 916 to the storage node because the object is assigned to the bucket 957A within the tenant 955A. That is, when an ingestion request 953 is submitted to the distributed storage system 802 for object 916, the request specifies the associated tenant 955A and identifies bucket 957A as the designated storage location. The gateway node processes the ingestion request 953 by authenticating the tenant 955A, validating the bucket 957A permissions, and determining the appropriate storage node, here the storage node 905C, for placement based on load balancing, storage availability, and Information Lifecycle Management (ILM) policies.

Once the storage node is selected, the object 916 is stored according to applicable object lock settings. As will be expanded on in greater detail below, the object lock settings may vary for the object 916 depending on application and configuration of the tenant 955A and/or the bucket 957A. In some embodiments, the ingestion request 953 may define object-lock settings 951 for the object 916. In such cases, the object-level lock settings 951 may be applied to the object 916 after ingestion.

As illustrated, one or more of the buckets 957A-F and 967A-F may define a set of object lock settings 959A-F and 969A-F, respectively. That is, each of the buckets 957A-F and 967A-F may have predefined object lock settings 959A-F and 969A-F governing objects assigned therein. As such, if the object 916 is ingested without object-level lock settings 951 defined, the object lock settings 959A-F of an assigned bucket 957A-F may be applied to the object 916. It should be appreciated that while the depicted example only illustrates object lock settings 959A-F and 969A-F as defined per bucket 957A-F and 967A-F, respectively, in some embodiments, the object lock settings may be defined on a tenant-level. That is one or more of the tenants 955A-C and/or 965A-C may have governing object lock settings. Additionally, while each bucket 957A-F and 967A-F is illustrated as having associated object lock settings 959A-F and 969A-F, respectively, in some embodiments, one or more of the bucket 957A-F and 967A-F and/or the tenants 955A-C and 965A-C may not have any defined object lock settings.

During cross-grid replication, the object 916 is replicated to the second grid 904B. In particular, the object 916 is replicated to a gateway node, such as the gateway node 811A, on the second grid 904B and directed to a respective storage node, such as the storage node 811E. In some embodiments, the gateway node on the second grid 904B directs the object 916, during the cross-grid replication process, to a respective storage node based on tenant and bucket assignments. That is, during the cross-grid replication process, the object 916 may be replicated to the tenant 965B on the second grid 904B, specifically to the bucket 967C within the tenant 965B. As shown, the bucket 967C defines the object lock settings 969C. To ensure that the object lock settings applied to the object 916 remain constant for the replicated object, an object lock engine, as described herein, is leveraged by the distributed storage system 802.

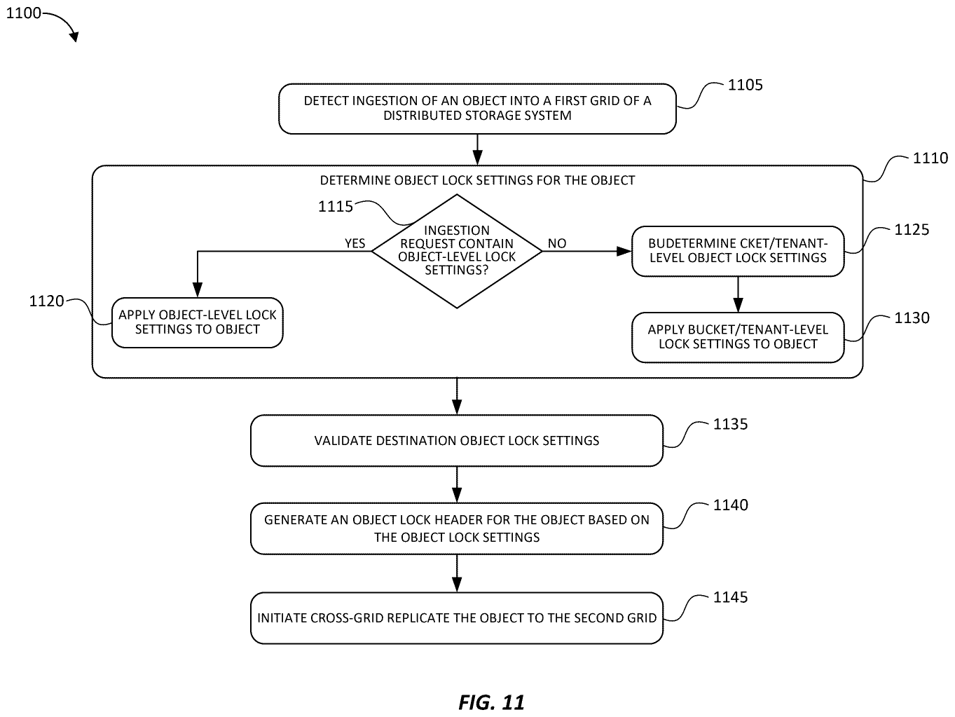

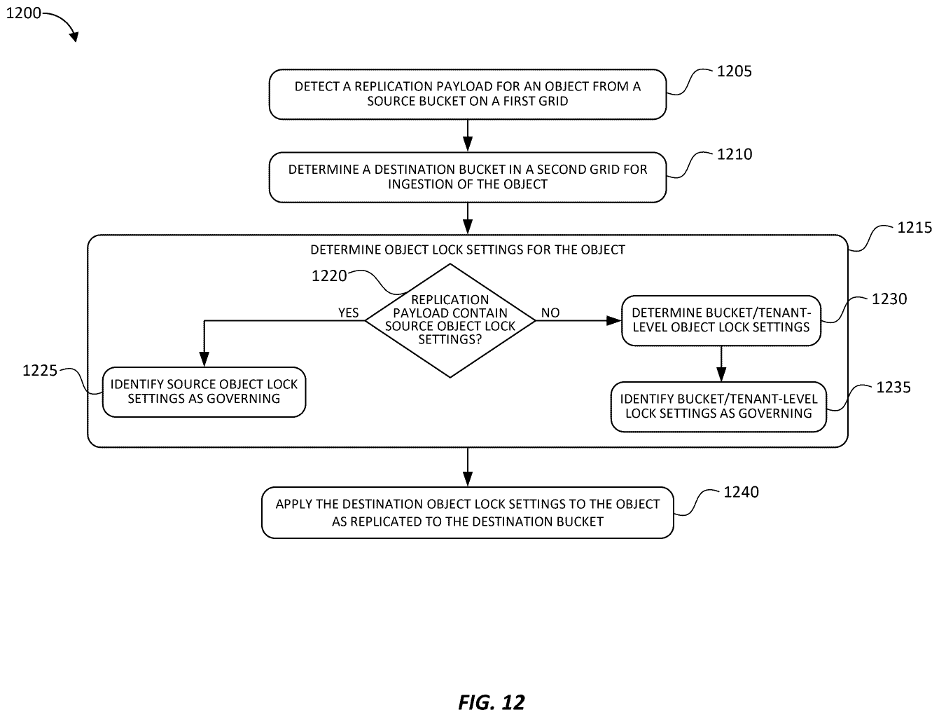

Referring now to FIG. 10, an example operational environment leveraging an object lock engine 1070 is illustrated, according to an embodiment herein. For ease of illustration, FIG. 10 is described with reference to FIGS. 11-12, initially focusing on source side functions of the object lock engine 1070, then the discussion focuses on destination side functions of the object lock engine 1070. FIG. 11 provides a process 1100 for providing an object lock engine, or one or more of its functions, on a source side, and FIG. 12 provides a process 1200 for providing an object lock engine, or one or more of its functions, on the destination side. The process 1100 provided in FIG. 11 and/or the process 1200 provided in FIG. 12 may be referred to herein as the object lock engine process. It should be appreciated that while the following discussion differentiates between a source side execution of the object lock engine 1070 and a destination side execution of the object lock engine 1070, in some embodiments, the object lock engine may be executed in a single instance or application that manages both the source side and destination side functions, as described below.

As illustrated, an object 1016, which may be the same or similar to the object 916, may be ingested into a source side 1074A of a distributed storage system 802. The source side 1074A may correspond to a first grid, such as the first grid 904A, of the distributed storage system 802. Similarly, a destination side 1074B may correspond to a second grid, such as the second grid 904B, within the distributed storage system. The source side 1074A includes a tenant 1055 containing a bucket 1057. The tenant 1055 and the bucket 1057 may be the same or similar to the tenants 955A-C and the buckets 957A-F, respectively. For ease of illustration, the source side 1074A is illustrated as containing a single tenant 1055 having a single bucket 1057. In real-world applications, however, the source side 1074A may contain any number of tenants 1055 having any number of buckets 1057 therein.

When the object 1016 is ingested into the source side 1074A, as described above, the object lock engine 1070 may detect the ingestion (1105). In particular, the object lock engine 1070 may include an ingestion detector 1071 that detects an ingestion request 1053 when submitted to the distributed storage system, such as to the tenant 1055 via the request 114A from a business application to the storage application. Responsive to ingestion of the object 1016, the object lock engine 1070 may determine object lock settings for the object 1016 (1010). To determine the object lock settings for the object 1016, the object lock engine 1070 may include a source object lock settings identifier 1073 (hereinafter “source identifier 1073”). The source identifier 1073 may determine which object lock settings should be applied to the object 1016 based on the application and configuration of the object 1016, tenant 1055, and/or the bucket 1057.

To determine source object lock settings for the object 1016 (e.g., which object lock settings to be applied on the source side 1074), the source identifier 1073 may parse the ingestion request 1053. That is, the source identifier 1073 may parse the ingestion request 1053 to determine whether it includes object-level lock settings 1051 (1115). As noted above, in some cases, the object 1016 may be submitted to the distributed storage system 802 for ingestion having defined object-level lock settings 1051. As such, if the source identifier 1073 determines that the ingestion request 1053 contains object-level lock settings 1051, the object lock engine 1070 may apply the object-level lock settings to the object 1016 as the source object lock settings (1120).

However, if the source identifier 1073 parses the ingestion request 1053 and determines that the ingestion request 1053 lacks object-level lock settings 1051 (e.g., the ingestion request 1053 does not include or identify object lock settings 1051 for the object 1016), then the source identifier 1073 may determine whether the bucket 1057 defines bucket-level lock settings 1059A or if the tenant 1055 defines tenant-level lock settings 1059B (1025). The bucket-level lock settings 1059A may be configured at the creation of the bucket 1057 or inherited from a system-wide default policies. If object lock is enabled at the bucket level, then the objects assigned to the bucket 1057, such as the object 1016, may be constrained and managed according to the bucket-level lock settings 1059A. Beyond the bucket-level lock settings 1059A, in some cases, the object lock engine 1074 may assess the tenant-level lock settings 1059B. The tenant-level lock settings 1059B may define global constraint or policies applicable across all buckets 1057 owned by the tenant 1055. The tenant-level lock settings 1059B may ensure consistency in data governance across the tenant's 1055 storage infrastructure.

Depending on the configuration of the source side 1074, the object lock engine 1070 may apply the bucket-level lock settings 1059A and/or the tenant-level lock settings 1059B to the object as the source object lock settings (1130). Application of the bucket-level and/or tenant-level object lock settings 1059A-B as the source object lock settings may vary on the hierarchical relationship between the tenant-level lock settings 1059B and bucket-level lock settings 1059A. In some embodiments, the bucket-level lock settings 1059A may supersede the tenant-level lock settings 1059B, while in other embodiments, the tenant-level lock settings 1059B may supersede the bucket-level lock settings 1059A. Additionally, in some embodiments, some rules or policies may be explicitly defined at either the tenant-level or bucket-level, while in other cases, one set of settings (1059A or 1059B) may override the other depending on predefined system rules or administrative configurations. The succession of object lock settings is often determined by regulatory requirements, organizational data governance mandates, or specific replication and storage configurations, ensuring that applied object lock settings align with both security policies and compliance obligations.

In an example embodiment, the object-level lock settings 1051 may supersede both of the bucket-level lock settings 1059A and the tenant-level lock settings 1059B. If the object 1016 is ingested without object-level lock settings 1051, the source identifier 1073 may determine whether the bucket-level lock settings 1059A are defined for the bucket 1057. If the bucket 1057 defines the bucket-level lock settings 1059A, then the object lock engine 1070 may apply the bucket-level lock settings 1059A as the source object lock settings. However, if the bucket 1057 does not contain bucket-level lock settings 1059A, then the source identifier 1073 may determine whether the tenant 1055 defines tenant-level lock settings 1059B. If so, then the object lock engine 1070 may apply the tenant-level lock settings 1059B as the source object lock settings. In the case where the tenant 1055 does not define tenant-level lock settings 1059B, then the object 1016 may be ingested without source object lock settings. However, depending on the configuration of the destination side 1074B, destination object lock settings may be applied, as described in greater detail below.

To ensure data redundancy, disaster recovery, regulatory compliance, and/or geographic accessibility, the object 1016 may be cross-grid replicated from a first grid on the source side 1074A to a second grid on the destination side 1074B. As illustrated, the destination side 1074B may include a tenant 1065 containing a bucket 1067, which may be the same or similar to the tenants 965A-C containing the buckets 967A-F, respectively. Similar to the source side 1074A, the destination side 1074B is depicted as containing a single tenant 1065 having a single bucket 1067 for ease of illustration. In real-world applications, the destination side 1074B may contain any number of tenants 1065 and buckets 1067.

In some embodiments, the object lock engine 1070 may validate destination object lock settings of the destination side 1074B (1135). That is, prior to cross-grid replication, the object lock engine 1070 may validate that the destination object lock settings match the source object lock settings. To perform this validation process, the object lock engine 1070 may include a validation module 1075. The validation module 1075 may determine what object lock settings are governing on the source side 1074A as the source side object lock settings and then determine what object lock settings govern on the destination side 1074B as the destination side object lock settings.

In some cases, the object lock engine 1070 may include a destination object lock settings identifier 1081 (hereinafter “the destination identifier 1081”) that determines the destination side object lock settings. Similar to the source side 1074A, the bucket 1067 may define bucket-level lock settings 1069A and the tenant 1065 may define tenant-level lock settings 1069B. Depending on the configuration of the destination side 1074B, one of the bucket-level or tenant-level lock settings 1069A-B may govern or a combination of the bucket-level or tenant level lock settings 1069A-B may govern. The destination identifier 1081 may determine the applicable destination object lock settings for the destination side 1074B accordingly.

In some cases, the destination identifier 1081 determines the destination object lock settings based on the tenant 1065 and/or bucket 1067 identified for the cross-grid replication process. For example, if the tenant 1065 and the bucket 1067 are designated for cross-grid replicating objects form the tenant 1055 and the bucket 1057, the destinated identifier 1081 determines the destination object lock settings based on this designation. Since in some cases, the destination side 1074B is configured to be a mirror of the source side 1074A in the context of cross-grid replication, the validation module 1075 may perform the validation process when the tenant 1065 and/or bucket 1067 are initially configured.

To validate the destination object lock settings, the validation module 1075 determines the destination object lock settings and compares them to the source object locks settings. In some cases, the validation process may verify that each policy within the destination object lock settings matches the source object lock settings, while in other cases, the validation process may merely ensure that object lock is enabled on the destination side 1074B. If the destination object lock settings match the source object lock settings (or that object lock is enabled), then the validation module 1075 may indicate that the destination object lock settings are valid. If the destination object lock settings are valid, then cross-grid replication between the source side 1074A and the destination side 1074B may be permitted. However, if the validation module 1075 determines a conflict between the destination object lock settings and the source object lock settings, the validation module 1075 may generate a validation error 1085. As will be described in greater detail below, the generation of the validation error 1085 may prevent cross-grid replication of the object 1016.

In some embodiments, the validation module 1075 may initiate the validation process responsive to detecting a cross-grid replication connection established between the source side 1074A and the destination side 1074B. For example, the validation module 1075 may detect the cross-grid replication connection established between the first grid 904A and the second grid 904B, and responsive to this connection, initiate the validation process. In some cases, cross-grid replication process may be paused or stalled until the validation process is completed and the destination object lock settings are validated against the source object lock settings.

Responsive to validating the destination object lock settings, the object lock engine 1070 may generate an object lock header 1079 for the object 1016 (1140). In particular, the object lock engine 1070 may include an object lock head generator 1077 that may generate the object lock header 1079 based on the source object lock settings. The object lock header 1079 may include the source object lock settings applied to the object 1016. In some embodiments, the object lock header 1079 is included in a replication payload 1040. The replication payload 1040, containing both the data and metadata of the object 1016, is transmitted from the source side 1074A to the destination side 1074B during cross-grid replication. By including the object lock header 1079 in the replication payload 1040, the source object lock settings are provided to the destination side 1074B during the replication process. The following is an example object lock header 1079 that may be generated for the object 1016:

```
{
  ″Object-ID″: ″a1b2c3d4-e5f6-7890-abcd-ef1234567890″,
  ″Retention-Mode″: ″COMPLIANCE″,
  ″Retention-Until-Date″: ″2035-03-25T00:00:00Z″,
  ″Legal-Hold-Status″: ″ON″,
  ″Lock-Creation-Date″: ″2025-03-25T14:52:00Z″,
  ″Originating-Grid-ID″: ″grid-904A″,
  ″Replication-Scope″: ″CROSS-GRID″,
  ″Lock-Version″: ″1.0″
}
```

Once the object lock header 1079 is generated and the destination object lock settings are validated, the object lock engine 1070 may initiate cross-grid replication of the object 1016 (1145). That is the object lock engine 1070 may clear or otherwise indicate that the object 1016 is ready for cross-grid replication. The object lock engine 1070 may coordinate with a cross-grid replication module 1046, which may be the same or similar to the CGR worker 546 as described above. As such, the cross-grid replication module 1046 may coordinate and/or perform one or more of the functions described above to replicate the object 1016 from a respective node on the source side 1074A to a respective node on the destination side 1074B.

As part of the cross-grid replication process, the cross-grid replication module 1046 may transmit the replication payload 1040 from the source side 1074A to the destination side 1074B. As described above, during the replication process, a gateway node on the destination side 1074B may receive the replication payload 1040 and direct the replication payload 1040 to a designated storage node within the second grid. When the replication payload 1040 is received on the destination side 1074B, the object lock engine 1070 may detect the replication payload 1040 (1025). In particular, the ingestion detector 1071 may detect the replication payload 1040 and ingestion of the object 1016 into the destination side 1074B. Responsive to receiving the replication payload 1040, the object lock engine 1070 may determine a destination bucket for ingestion of the object 1016 (1210). That is, the object lock engine 1070 may determine that the bucket 1067 is designated for the object 1016 based on the replication payload 1040 and/or the underlying designated storage node in the second grid.

The object lock engine 1070 then determines object lock settings for the object 1016 (1215). In particular, the destination identifier 1081 may determine destination object lock settings for the object 1016. To determine the destination object lock settings for the object, the destination identifier 1081 may determine whether the replication payload 1040 contained source object lock settings (1220). That is, the destination identifier 1081 may parse the replication payload 1040 for the object lock header 1079. If the replication payload 1040 contains the object lock header 1079, then the object lock engine 1070 may apply the source object lock settings to the object 1016 as replicated on the destination side 1074B (1225). In an example embodiment, the destination side 1074B may not contain bucket-level or tenant-level lock settings 1069A-B. As such, the object lock engine 1070 may identify the source object level settings as provided in the replication payload 1040 as the destination object lock settings.

However, if the replication payload 1040 does not contain source object lock settings for the object 1016, then the destination identifier 1081 may determine whether the bucket-level lock settings 1069A for the bucket 1067 and/or the tenant-level lock settings 1069B govern, as described above (1230). Once the applicable bucket-level and/or tenant-level lock settings 1069A-B are identified, then object lock engine 1070 may identify the respective object lock settings (1069A-B) as the destination object lock settings to the object 1016.

In an example embodiment, if the replication payload 1040 includes the source object lock settings, then the object lock engine 1070 may apply the source object lock settings as the destination object locks settings to the object 1016. However, if the object lock engine 1070 determines that the replication payload 1040 includes the source object lock settings but that the destination side 1074B also contains governing bucket-level and/or tenant-level lock settings 1069A-B, the object lock engine 1070 may determine whether there is any conflict between the source and destination object lock settings.

As illustrated, the object lock engine 1070 may include a conflict detector 1083 which may detect when both the source and destination object lock settings are defined for the object 1016. If the conflict detector 1083 detects that the replication payload 1040 contains the source object lock settings and that the destination side 1074B contains one or both of bucket-level and tenant-level lock settings 1069A-B, the conflict detector 1083 may compare the source and destination object lock settings to determine whether there is any conflict. In some cases, the conflict detector 1083 may detect a conflict if the destination object lock settings do not match the source object lock settings, while in other embodiments, the conflict detector 1083 may detect a conflict when a policy or rule within one or both of the source and destination object lock settings are at odds.

If the conflict detector 1083 detects a conflict between the destination object lock settings and the source object lock settings, the object lock engine 1070 may generate a validation error 1085. The validation error 1085 may indicate the discrepancy between the source and destination object lock settings. In some cases, generation of the validation error 1085 may prevent cross-grid replication of the object 1016. The validation error 1085 may be provided to a client device 1010, which may be the same or similar to the client device 110. The client device 1110 may be the client device that submitted the ingestion request 1053 for ingestion of the object 1016 into the source side 1074A. In some cases, the client device 1110 may initiate the cross-grid replication of the object 1016, while in other cases cross-grid replication of the object 1016 may be performed automatically by the distributed storage system.

Responsive to receiving the validation error 1085, the client device 110 may be prompted to modify the destination object lock settings. For example, if the conflict detector 1083 determines a conflict between the bucket-level lock settings 1069A and the source object lock settings, the validation error 1085 may prompt the client device 1010 to modify the bucket-level lock settings 1069B. The object lock engine 1070 may detect when the client device 1010 makes a modification 1087 to the destination object lock settings. In some cases, cross-grid replication of the object 1016 may be paused or inhibited until the modification 1078 is received. Responsive to receiving the modification 1078, the object lock engine 1070 may reinitiate the cross-grid replication process or may prompt the client device 1010 to restart the cross-grid replication process. In yet other cases, the client device 1010 may be required to re-ingest the object 1016 into the source side 1074A to attempt cross-grid replication again. It should be appreciated that while the above describes modifying the destination object lock settings, in some cases, the modification 1087 may be made with respect to the source object lock settings.

When the object lock engine 1070 determines the destination object lock settings for the object 1016 as replicated to the destination side 1074B, the object lock engine 1070 applies the destination object lock settings to the object as replicated to the bucket 1067 (1240). Once applied, the destination object lock settings may govern the object 1016 as replicated. That is, constraints defined by the destination object lock settings may govern. For example, if the destination object lock settings define a retention mode, such as a compliance mode where the object lock settings cannot be modified for the object 1016, if a user attempts to modify the object lock settings of the replicated object, such a request is denied based on the object lock settings. Similarly, the object 1016 as replicated on the destination side 1074B may be retained according to a retention period defined by the destination object lock settings. Once the retention period is reached, the object lock engine 1070 may flag or mark the object 1016 as replicated as available for deletion.

Referring now to FIG. 13, is a diagram of a system 1300 configured to implement one or more steps of a cross-grid replication process and/or the object lock engine process described herein, according to an embodiment. The system 1300 may be an example of an apparatus including a computing apparatus 1390 that is representative of any system or collection of systems in which the various processes, systems, programs, services, and scenarios disclosed herein may be implemented. For example, computing apparatus 1390 may be an example node, such as the storage node 205B, or may be a client device, such as the client device 110, or any of the subcomponents depicted in systems 100, 202, 500, 802, 900, or 1000 of FIGS. 1, 2, 5, 8, 9, and 10 respectively. Examples of computing apparatus 1390 include, but are not limited to, server computers, desktop computers, laptop computers, routers, switches, web servers, cloud computing platforms, and data center equipment, as well as any other type of physical or virtual server machine, physical or virtual router, container, and any variation or combination thereof.

Computing apparatus 1390 may be implemented as a single apparatus, system, or device or may be implemented in a distributed manner as multiple apparatuses, systems, or devices. Computing apparatus 1390 may include, but is not limited to, processing system 1398, storage system 1392, software 1394, communication interface system 1397, and user interface system 1399. Processing system 1398 may be operatively coupled with storage system 1392, communication interface system 1397, and user interface system 1399.

Processing system 1398 may load and execute software 1394 from storage system 1392. Software 1394 may include cross-grid replication (CGR) process 1396, which may be representative of one or more steps of the cross-grid replication process or intra-grid replication process, as discussed with respect to the preceding figures. The software 1394 may also include an object lock engine 1370, which may provide one or more object lock setting functions as described herein. When executed by processing system 1398, software 1394 may direct processing system 1398 to operate as described herein for at least the various processes, such as the processes 300, 600, 1100, and 1200, operational scenarios, and sequences discussed in the foregoing implementations. Computing apparatus 1390 may optionally include additional devices, features, or functionality not discussed for purposes of brevity.

In some embodiments, processing system 1398 may comprise a micro-processor and other circuitry that retrieves and executes software 1394 from storage system 1392. Processing system 1398 may be implemented within a single processing device but may also be distributed across multiple processing devices or sub-systems that cooperate in executing program instructions. Examples of processing system 1398 may include general purpose central processing units, graphical processing units, application specific processors, and logic devices, as well as any other type of processing device, combinations, or variations thereof.

Storage system 1392 may comprise any memory device or computer readable storage media readable by processing system 1398 and capable of storing software 1394. Storage system 1392 may include volatile and nonvolatile, removable and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 1392 may also include computer readable communication media over which at least some of software 1394 may be communicated internally or externally. Storage system 1392 may be implemented as a single storage device but may also be implemented across multiple storage devices or sub-systems co-located or distributed relative to each other. Storage system 1392 may comprise additional elements, such as a controller, capable of communicating with processing system 1398 or possibly other systems.

Software 1394 (including cross-grid replication process 1396 and/or the object lock engine 1370 among other functions) may be implemented in program instructions that may, when executed by processing system 1398, direct processing system 1398 to operate as described with respect to the various operational scenarios, sequences, and processes illustrated herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 1394 may include additional processes, programs, or components, such as operating system software, virtualization software, or other application software. Software 1394 may also comprise firmware or some other form of machine-readable processing instructions executable by processing system 1398.

In general, software 1394 may, when loaded into processing system 1398 and executed, transform a suitable apparatus, system, or device (of which computing apparatus 1390 is representative) overall from a general-purpose computing system into a special-purpose computing system as described herein. Indeed, encoding software 1394 on storage system 1392 may transform the physical structure of storage system 1392. The specific transformation of the physical structure may depend on various factors in different implementations of this description. Examples of such factors may include, but are not limited to, the technology used to implement the storage media of storage system 1392 and whether the computer-storage media are characterized as primary or secondary storage, as well as other factors.

For example, if the computer readable storage media are implemented as semiconductor-based memory, software 1394 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 1397 may include communication connections and devices that allow for communication with other computing systems (not shown) over communication networks (not shown). Examples of connections and devices that together allow for inter-system communication may include network interface cards, antennas, power amplifiers, radio-frequency (RF) circuitry, transceivers, and other communication circuitry. The connections and devices may communicate over communication media to exchange communications with other computing systems or networks of systems, such as metal, glass, air, or any other suitable communication media.

Communication between the computing apparatus 1390 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

While some examples of methods and systems herein are described in terms of software executing on various machines, the methods and systems may also be implemented as specifically-configured hardware, such as field-programmable gate array (FPGA) specifically to execute the various methods according to this disclosure. For example, examples can be implemented in digital electronic circuitry, or in computer hardware, firmware, software, or in a combination thereof. In one example, a device may include a processor or processors. The processor comprises a computer-readable medium, such as a random access memory (RAM) coupled to the processor. The processor executes computer-executable program instructions stored in memory, such as executing one or more computer programs. Such processors may comprise a microprocessor, a digital signal processor (DSP), an application-specific integrated circuit (ASIC), field programmable gate arrays (FPGAs), and state machines. Such processors may further comprise programmable electronic devices such as PLCs, programmable interrupt controllers (PICs), programmable logic devices (PLDs), programmable read-only memories (PROMs), electronically programmable read-only memories (EPROMs or EEPROMs), or other similar devices.

Such processors may comprise, or may be in communication with, media, for example one or more non-transitory computer-readable media, which may store processor-executable instructions that, when executed by the processor, can cause the processor to perform methods according to this disclosure as carried out, or assisted, by a processor. Examples of non-transitory computer-readable medium may include, but are not limited to, an electronic, optical, magnetic, or other storage device capable of providing a processor, such as the processor in a web server, with processor-executable instructions. Other examples of non-transitory computer-readable media include, but are not limited to, a floppy disk, CD-ROM, magnetic disk, memory chip, ROM, RAM, ASIC, configured processor, all optical media, all magnetic tape or other magnetic media, or any other medium from which a computer processor can read. The processor, and the processing, described may be in one or more structures, and may be dispersed through one or more structures. The processor may comprise code to carry out methods (or parts of methods) according to this disclosure.

As will be appreciated by one skilled in the art, aspects of the present invention may be embodied as a system, method, computer program product, and other configurable systems. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more memory devices or computer-readable storage medium(s) having computer readable program code embodied thereon.

The foregoing examples and descriptions are described herein in the context of systems and methods for performing cross-grid replication, including managing object lock settings for objects during cross-grid replication, within a distributed storage system. Those of ordinary skill in the art will realize that these descriptions are illustrative only and are not intended to be in any way limiting. Reference is made in detail to implementations of examples as illustrated in the accompanying drawings. The same reference indicators are used throughout the drawings and the description to refer to the same or like items.

In the interest of clarity, not all of the routine features of the examples described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. That is, the foregoing description of some examples has been presented only for the purpose of illustration and description and is not intended to be exhaustive or to limit the disclosure to the precise forms disclosed. Numerous modifications and adaptations thereof will be apparent to those skilled in the art without departing from the spirit and scope of the disclosure.

Reference herein to an example or implementation means that a particular feature, structure, operation, or other characteristic described in connection with the example may be included in at least one implementation of the disclosure. The disclosure is not restricted to the particular examples or implementations described as such. The appearance of the phrases “in one example,” “in an example,” “in an embodiment,” or “in an implementation,” or variations of the same in various places in the specification does not necessarily refer to the same example or implementation. Any particular feature, structure, operation, or other characteristic described in this specification in relation to one example or implementation may be combined with other features, structures, operations, or other characteristics described in respect of any other example or implementation.

Use herein of the word “or” is intended to cover inclusive and exclusive OR conditions. In other words, A or B or C includes any or all of the following alternative combinations as appropriate for a particular usage: A alone; B alone; C alone; A and B only; A and C only; B and C only; and A and B and C.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number respectively. The word “or,” in reference to a list of two or more items, covers all the following interpretations of the word: any of the items in the list, all the items in the list, and any combination of the items in the list.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or sub combinations. Each of these processes or blocks may be implemented in a variety of different ways. Also, while processes or blocks are at times shown as being performed in series, these processes or blocks may instead be performed or implemented in parallel, or may be performed at different times. Further any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

### EXAMPLES

These illustrative examples are mentioned not to limit or define the scope of this disclosure, but rather to provide examples to aid understanding thereof. Illustrative examples are discussed above in the Detailed Description, which provides further description. Advantages offered by various examples may be further understood by examining this specification.

As used below, any reference to a series of examples is to be understood as a reference to each of those examples disjunctively (e.g., “Examples 1-4” is to be understood as “Examples 1, 2, 3, or 4”).

Example 1 is a computing apparatus comprising: a computer-readable storage medium having processor-executable instructions stored thereon; and one or more processors coupled to the computer-readable storage medium and configured to execute the processor-executable instructions to: ingest an object into a source bucket on a first grid of a distributed storage system; determine object lock settings for the object; generate an object lock header for the object based on the object lock settings; and cross-grid replicate the object with the object lock header from the source bucket to a destination bucket in a second grid within the distributed storage system, wherein responsive to cross-grid replicating the object, the destination bucket in the second grid applies the object lock settings according to the object lock header.

Example 2 is the computing apparatus of any previous or subsequent Example, the processor-executable instructions to determine object lock settings for the object, when executed by the one or more processors, further direct the computing apparatus to: determine source object lock settings of the source bucket; and apply the source object lock settings to the object as the object lock settings.

Example 3 is the computing apparatus of any previous or subsequent Example, wherein the processor-executable instructions to generate the object lock header for the object based on the object lock settings, when executed by the one or more processors, further direct the computing apparatus to: generate a replication payload comprising object data, object metadata, and the object lock header, wherein the object lock header comprises the object lock settings of the object.

Example 4 is the computing apparatus of any previous or subsequent Example, wherein the first grid comprises a first tenant and the second grid comprises a second tenant; and the processor-executable instructions, when executed by the one or more processors, further direct the computing apparatus to: detect a cross-grid replication connection established between the first grid and the second grid; determine source object lock settings of the first tenant on the first grid, wherein the first tenant comprises the source bucket; determine destination object lock settings of the second tenant on the second grid, wherein the second tenant comprises the destination bucket; and validate that the source object lock settings match the destination object lock settings.

Example 5 is the computing apparatus of any previous or subsequent Example, the processor-executable instructions to determine object lock settings for the object, when executed by the one or more processors, further direct the computing apparatus to: parse an ingestion request associated with the object for object-level lock settings; determine source object lock settings of the source bucket; determine a conflict between the object-level lock settings and the source object lock settings; and apply the object-level lock settings to the object as the object lock settings.

Example 6 is the computing apparatus of any previous or subsequent Example, wherein the first grid comprises a first tenant and the second grid comprises a second tenant, and the processor-executable instructions, when executed by the one or more processors, further direct the computing apparatus to: transmit a request from the first tenant on the first grid to the second tenant on the second grid to verify that object lock is enabled for the destination bucket, wherein the second tenant comprises the destination bucket; receive a response from the second tenant on the second grid indicating that object lock is disabled for the destination bucket; and pause cross-grid replication of the object from the source bucket to the destination bucket based on the response.

Example 7 is a method comprising: detecting, by a source-side object lock engine, ingestion of an object into a first grid of a distributed storage system; determining, by the source-side object lock engine, object lock settings for the object, wherein the object lock settings determine a retention policy of the object within the distributed storage system; cross-grid replicating the object from the first grid to a second grid in the distributed storage system; and applying, by a destination-side object lock engine, the object lock settings for the object within the second grid.

Example 8 is the method of any previous or subsequent Example, wherein the object is ingested into a source bucket on the first grid; and the determining, by the source-side object lock engine, the object lock settings for the object further comprises: parsing, by the source-side object lock engine, metadata of the object as ingested into the first grid for object-level lock settings; determining, by the source-side object lock engine, source object lock settings associated with the source bucket; and applying, by the source-side object lock engine, the source object lock settings to the object as the object lock settings based on the metadata lacking object-level lock settings.

Example 9 is the method of any previous or subsequent Example, wherein: the object is ingested into a source bucket on the first grid and cross-grid replicated to a destination bucket on the second grid; and applying, by the destination-side object lock engine, the object lock settings for the object within the second grid further comprises: parsing, by the destination-side object lock engine, a replication payload received during the cross-grid replication of the object, wherein the replication payload comprises source object lock settings of the source bucket; determining, by the destination-side object lock engine, destination object lock settings of the destination bucket; detecting, by the destination-side object lock engine, a conflict between the destination object lock settings of the destination bucket and the source object lock settings of the source bucket; and applying, by the destination-side object lock engine, the source object lock settings to the object as the object lock settings for the object as ingested into the destination bucket.

Example 10 is the method of any previous or subsequent Example, wherein: the method further comprises: generating, by the source-side object lock engine, a replication payload for cross-grid replicating the object, wherein the replication payload comprises object data, object metadata, and an object lock header comprising the object lock settings of the object; and cross-grid replicating the object from the first grid to the second grid in the distributed storage system further comprises: transmitting the replication payload from a first node on the first grid to a second node on the second grid.

Example 11 is the method of any previous or subsequent Example, wherein: the object is ingested into a source bucket on the first grid and cross-grid replicated to a destination bucket on the second grid; and prior to cross-grid replicating the object from the first grid to a second grid in the distributed storage system, the method further comprises: validating, by the source-side object lock engine, that destination object lock settings of the destination bucket match source object lock settings of the source bucket, wherein cross-grid replication is initiated responsive to the validation.

Example 12 is the method of any previous or subsequent Example, wherein the method further comprises: detecting, by the source-side object lock engine, ingestion of a second object into the first grid of the distributed storage system; cross-grid replicating the second object from the first grid to the second grid in the distributed storage system, wherein the second object is cross-gird replicated to one or more of a destination tenant or a destination bucket on the second grid; parsing, by the destination-side object lock engine, a replication payload associated with the second object as part of the cross-grid replication; detecting, by the destination-side object lock engine, that the replication payload lacks an object lock header; determining, by the destination-side object lock engine, destination object lock settings for at least one of the destination tenant or the destination bucket; and applying, by the destination-side object lock engine, the destination object lock settings to the second object as the object lock settings for the object.

Example 13 is the method of any previous or subsequent Example, wherein prior to cross-grid replicating the object from the first grid to a second grid in the distributed storage system, the method further comprises: establishing a cross-grid replication connection between a first tenant of the first grid and a second tenant of the second grid; determining, by the destination-side object lock engine, source object lock settings of the first tenant on the first grid; determining, by the destination-side object lock engine, destination object lock settings of the second tenant on the second grid; determining, by the destination-side object lock engine, a conflict between the destination object lock settings and the source object lock settings; preventing cross-grid replication of the object from the first grid to the second grid based on the conflict; requesting modification of the destination object lock settings based on the conflict; and reinitiating cross-grid replication of the object from the first grid to the second grid responsive to detecting the modification of the destination object lock settings.

Example 14 is a non-transitory computer-readable storage medium comprising processor-executable instructions configured to cause one or more processors to: detect, by an object lock engine, a replication payload for an object from a source bucket on a first grid within a distributed storage system as part of a cross-grid replication process; determine, by the object lock engine, a destination bucket in a second grid within the distributed storage system for ingestion of the object; determine, by the object lock engine, object lock settings for the object; and ingest the object into the destination bucket on the second grid according to the object lock settings.

Example 15 is the non-transitory computer-readable storage medium of any previous or subsequent Example, wherein the processor-executable instructions to determine, by the object lock engine, the object lock settings for the object are configured to further cause the one or more processors to: parse, by the object lock engine, the replication payload for an object lock header; determine, by the object lock engine, that the replication payload lacks the object lock header; determine, by the object lock engine, destination object lock settings of the destination bucket; and apply, by the object lock engine, the destination object lock settings to the object as the object lock settings for the object.

Example 16 is the non-transitory computer-readable storage medium of any previous or subsequent Example, wherein the processor-executable instructions to determine, by the object lock engine, the object lock settings for the object are configured to further cause the one or more processors to: parse, by the object lock engine, the replication payload for an object lock header, wherein the object lock header comprises source object lock settings from the source bucket on the first grid; determine, by the object lock engine, destination object lock settings of the destination bucket; detect, by the object lock engine, a conflict between the destination object lock settings and the source object lock settings; and apply, by the object lock engine, the source object lock settings to the object as the object lock settings for the object as ingested into the destination bucket.

Example 17 is the non-transitory computer-readable storage medium of any previous or subsequent Example, wherein the processor-executable instructions are configured to further cause the one or more processors to: detect, by the object lock engine, a second replication payload for a second object from a second source bucket on the first grid during a cross-grid replication process of the second object; determine, by the object lock engine, the destination bucket in the second grid for ingestion of the object; parse, by the object lock engine, the second replication payload for an object lock header, wherein the object lock header comprises source object lock settings from the second source bucket on the first grid; determine, by the object lock engine, destination object lock settings of the destination bucket; detect, by the object lock engine, a conflict between the destination object lock settings and the source object lock settings; generate, by the object lock engine, a validation error for the cross-grid replication process of the second object based on the conflict between the destination object lock settings and the source object lock settings; and stop the cross-grid replication process of the second object based on the validation error.

Example 18 is the non-transitory computer-readable storage medium of any previous or subsequent Example, wherein the processor-executable instructions to determine, by the object lock engine, the object lock settings for the object are configured to further cause the one or more processors to: detect, by the object lock engine, a conflict between destination object lock settings of the destination bucket and source object lock settings of the source bucket; generate, by the object lock engine, a validation error for the cross-grid replication process based on the conflict between the destination object lock settings and the source object lock settings; pause, by the object lock engine, the cross-grid replication process of the object into the destination bucket based on the validation error; responsive to the validation error, detect, by the object lock engine, a modification to the destination object lock settings; and reinitiate, by the object lock engine, the cross-grid replication process of the object into the destination bucket based on the modification to the destination object lock settings.

Example 19 is the non-transitory computer-readable storage medium of any previous or subsequent Example, wherein the processor-executable instructions are configured to further cause the one or more processors to: determine, by the object lock engine, a retention period of the object based on the object lock settings; determine, by the object lock engine, that a current date is the retention period; and mark, by the object lock engine, the object for deletion from the bucket after the current date.

Example 20 is the non-transitory computer-readable storage medium of any previous or subsequent Example, wherein the processor-executable instructions are configured to further cause the one or more processors to: receive, by the object lock, a request to override the object lock settings for the object; determine, by the object lock engine, a retention mode for the object based on the object lock settings; and deny, by the object lock engine, the request to override the object lock setting based on the retention mode of the object.

What is claimed is:

1. A computing apparatus comprising:
a computer-readable storage medium having processor-executable instructions stored thereon; and
one or more processors coupled to the computer-readable storage medium and configured to execute the processor-executable instructions to:
ingest an object into a source bucket on a first grid of a distributed storage system;
determine object lock settings for the object;
generate an object lock header for the object based on the object lock settings; and
cross-grid replicate the object with the object lock header from the source bucket to a destination bucket in a second grid within the distributed storage system, wherein responsive to cross-grid replicating the object, the destination bucket in the second grid applies the object lock settings according to the object lock header.

2. The computing apparatus of claim 1, the processor-executable instructions to determine object lock settings for the object, when executed by the one or more processors, further direct the computing apparatus to:
determine source object lock settings of the source bucket; and
apply the source object lock settings to the object as the object lock settings.

3. The computing apparatus of claim 1, wherein the processor-executable instructions to generate the object lock header for the object based on the object lock settings, when executed by the one or more processors, further direct the computing apparatus to:
generate a replication payload comprising object data, object metadata, and the object lock header, wherein the object lock header comprises the object lock settings of the object.

4. The computing apparatus of claim 1, wherein the first grid comprises a first tenant and the second grid comprises a second tenant; and
the processor-executable instructions, when executed by the one or more processors, further direct the computing apparatus to:
detect a cross-grid replication connection established between the first grid and the second grid;
determine source object lock settings of the first tenant on the first grid, wherein the first tenant comprises the source bucket;
determine destination object lock settings of the second tenant on the second grid, wherein the second tenant comprises the destination bucket; and
validate that the source object lock settings match the destination object lock settings.

5. The computing apparatus of claim 1, the processor-executable instructions to determine object lock settings for the object, when executed by the one or more processors, further direct the computing apparatus to:
parse an ingestion request associated with the object for object-level lock settings;
determine source object lock settings of the source bucket;
determine a conflict between the object-level lock settings and the source object lock settings; and
apply the object-level lock settings to the object as the object lock settings.

6. The computing apparatus of claim 1, wherein the first grid comprises a first tenant and the second grid comprises a second tenant, and the processor-executable instructions, when executed by the one or more processors, further direct the computing apparatus to:
transmit a request from the first tenant on the first grid to the second tenant on the second grid to verify that object lock is enabled for the destination bucket, wherein the second tenant comprises the destination bucket;
receive a response from the second tenant on the second grid indicating that object lock is disabled for the destination bucket; and
pause cross-grid replication of the object from the source bucket to the destination bucket based on the response.

7. A method comprising:
detecting, by a source-side object lock engine, ingestion of an object into a first grid of a distributed storage system;
determining, by the source-side object lock engine, object lock settings for the object, wherein the object lock settings determine a retention policy of the object within the distributed storage system;
cross-grid replicating the object from the first grid to a second grid in the distributed storage system; and
applying, by a destination-side object lock engine, the object lock settings for the object within the second grid.

8. The method of claim 7, wherein the object is ingested into a source bucket on the first grid; and the determining, by the source-side object lock engine, the object lock settings for the object further comprises:
parsing, by the source-side object lock engine, metadata of the object as ingested into the first grid for object-level lock settings;
determining, by the source-side object lock engine, source object lock settings associated with the source bucket; and
applying, by the source-side object lock engine, the source object lock settings to the object as the object lock settings based on the metadata lacking object-level lock settings.

9. The method of claim 7, wherein:
the object is ingested into a source bucket on the first grid and cross-grid replicated to a destination bucket on the second grid; and
applying, by the destination-side object lock engine, the object lock settings for the object within the second grid further comprises:
parsing, by the destination-side object lock engine, a replication payload received during the cross-grid replication of the object, wherein the replication payload comprises source object lock settings of the source bucket;
determining, by the destination-side object lock engine, destination object lock settings of the destination bucket;
detecting, by the destination-side object lock engine, a conflict between the destination object lock settings of the destination bucket and the source object lock settings of the source bucket; and
applying, by the destination-side object lock engine, the source object lock settings to the object as the object lock settings for the object as ingested into the destination bucket.

10. The method of claim 7, wherein the method further comprises:
generating, by the source-side object lock engine, a replication payload for cross-grid replicating the object, wherein the replication payload comprises object data, object metadata, and an object lock header comprising the object lock settings of the object; and
cross-grid replicating the object from the first grid to the second grid in the distributed storage system further includes:
transmitting the replication payload from a first node on the first grid to a second node on the second grid.

11. The method of claim 7, wherein:
the object is ingested into a source bucket on the first grid and cross-grid replicated to a destination bucket on the second grid; and
prior to cross-grid replicating the object from the first grid to a second grid in the distributed storage system, the method further includes:
validating, by the source-side object lock engine, that destination object lock settings of the destination bucket match source object lock settings of the source bucket, wherein cross-grid replication is initiated responsive to the validation.

12. The method of claim 7, wherein the method further comprises:
detecting, by the source-side object lock engine, ingestion of a second object into the first grid of the distributed storage system;
cross-grid replicating the second object from the first grid to the second grid in the distributed storage system, wherein the second object is cross-gird replicated to one or more of a destination tenant or a destination bucket on the second grid;
parsing, by the destination-side object lock engine, a replication payload associated with the second object as part of the cross-grid replication;
detecting, by the destination-side object lock engine, that the replication payload lacks an object lock header;
determining, by the destination-side object lock engine, destination object lock settings for at least one of the destination tenant or the destination bucket; and
applying, by the destination-side object lock engine, the destination object lock settings to the second object as the object lock settings for the object.

13. The method of claim 7, wherein prior to cross-grid replicating the object from the first grid to a second grid in the distributed storage system, the method further comprises:
establishing a cross-grid replication connection between a first tenant of the first grid and a second tenant of the second grid;
determining, by the destination-side object lock engine, source object lock settings of the first tenant on the first grid;
determining, by the destination-side object lock engine, destination object lock settings of the second tenant on the second grid;
determining, by the destination-side object lock engine, a conflict between the destination object lock settings and the source object lock settings;
preventing cross-grid replication of the object from the first grid to the second grid based on the conflict;
requesting modification of the destination object lock settings based on the conflict; and
reinitiating cross-grid replication of the object from the first grid to the second grid responsive to detecting the modification of the destination object lock settings.

14. A non-transitory computer-readable storage medium comprising processor-executable instructions configured to cause one or more processors to:
detect a replication payload for an object from a source bucket on a first grid within a distributed storage system as part of a cross-grid replication process;
determine a destination bucket in a second grid within the distributed storage system for ingestion of the object;
determine object lock settings for the object; and
ingest the object into the destination bucket on the second grid according to the object lock settings.

15. The non-transitory computer-readable storage medium of claim 14, wherein the processor-executable instructions to determine the object lock settings for the object are configured to further cause the one or more processors to:
parse the replication payload for an object lock header;
determine that the replication payload lacks the object lock header;
determine destination object lock settings of the destination bucket; and
apply the destination object lock settings to the object as the object lock settings for the object.

16. The non-transitory computer-readable storage medium of claim 14, wherein the processor-executable instructions to determine, by the object lock engine, the object lock settings for the object are configured to further cause the one or more processors to:
parse the replication payload for an object lock header, wherein the object lock header comprises source object lock settings from the source bucket on the first grid;
determine destination object lock settings of the destination bucket;
detect a conflict between the destination object lock settings and the source object lock settings; and
apply the source object lock settings to the object as the object lock settings for the object as ingested into the destination bucket.

17. The non-transitory computer-readable storage medium of claim 14, wherein the processor-executable instructions are configured to further cause the one or more processors to:
detect a second replication payload for a second object from a second source bucket on the first grid during a cross-grid replication process of the second object;
determine the destination bucket in the second grid for ingestion of the object;
parse the second replication payload for an object lock header, wherein the object lock header comprises source object lock settings from the second source bucket on the first grid;
determine destination object lock settings of the destination bucket;
detect a conflict between the destination object lock settings and the source object lock settings;
generate a validation error for the cross-grid replication process of the second object based on the conflict between the destination object lock settings and the source object lock settings; and
stop the cross-grid replication process of the second object based on the validation error.

18. The non-transitory computer-readable storage medium of claim 14, wherein the processor-executable instructions to determine, by the object lock engine, the object lock settings for the object are configured to further cause the one or more processors to:
detect a conflict between destination object lock settings of the destination bucket and source object lock settings of the source bucket;
generate a validation error for the cross-grid replication process based on the conflict between the destination object lock settings and the source object lock settings;
pause the cross-grid replication process of the object into the destination bucket based on the validation error;
responsive to the validation error, detect a modification to the destination object lock settings; and
reinitiate the cross-grid replication process of the object into the destination bucket based on the modification to the destination object lock settings.

19. The non-transitory computer-readable storage medium of claim 14, wherein the processor-executable instructions are configured to further cause the one or more processors to:
determine a retention period of the object based on the object lock settings;
determine that a current date is the retention period; and
mark the object for deletion from the bucket after the current date.

20. The non-transitory computer-readable storage medium of claim 14, wherein the processor-executable instructions are configured to further cause the one or more processors to:
receive a request to override the object lock settings for the object;
determine a retention mode for the object based on the object lock settings; and
deny the request to override the object lock setting based on the retention mode of the object.
